(19) United States
(12) Patent Application Publication
(10) Pub. No.: US 2011/0005008 A1
(43) Pub. Date: Jan. 13, 2011

(54) VINYL ACETATE/ETHYLENE (VAE) COPOLYMERS FOR FABRIC FINISHING

(76) Inventors: Harrie P. Schoots, Houston, TX (US); Neeraj Nagpal, Powai Mumbai (IN); Dalia I. Eicken, Houston, TX (US); Vinh V. Nguyen, Pearland, TX (US); Jennifer S. Kauffman, Friendswood, TX (US)

Correspondence Address: HAMMER & ASSOCIATES, P.C., 3125 SPRINGBANK LANE, SUITE G, CHARLOTTE, NC, 28226, US

(21) Appl. No.: 12/760,908

(22) Filed: Apr. 15, 2010

Related U.S. Application Data
(60) Provisional application No. 61/202,885, filed on Apr. 16, 2009.

(51) Int. Cl. D06P 1/52; B29C 70/30

(52) U.S. Cl. 8/495; 8/130.1; 8/133; 8/147; 156/243

(57) ABSTRACT

A method of finishing a textile comprising the steps of: (a) preparing an aqueous finishing liquor comprising from 0.05 wt. % solids to 65 wt. % solids of a finishing resin selected from the group comprising: vinyl acetate emulsion resins, including copolymers such as vinyl acetate ethylene emulsions, vinyl acetate acrylics, acrylic emulsions, polyvinyl alcohol resins, including polyvinyl alcohol vinyl formamide copolymers, polyvinyl alcohol vinyl amine copolymers, sulfonic acid functionalized polyvinyl alcohol resins, modified polyvinyl alcohol resins generally; and mixtures thereof; (b) saturating the textile with the finishing liquor to incorporate the liquor into the textile so as to provide a wetted textile; and (c) processing the wetted textile at elevated temperature under conditions which are controlled such that the finishing resin is inter-associated with the fibers of the textile; wherein the finishing resin is durably and uniformly inter-associated with the textile fiber surfaces at an add-on level of from 0.05 wt. % to less than 65 wt. % and is operative to alter at least one comfort-related property of the textile.

### RELATED CASES

This application claims the priority of the provisional application Ser. No. 61/202,885 filed on Apr. 16, 2009.

### FIELD OF THE INVENTION

The present invention relates to textile finishing; in a preferred embodiment, using vinyl acetate based emulsions such as vinyl acetate/ethylene emulsions. The inventive techniques provide unique physical properties such as recovery from compression, bending and frictional properties as well as unique appearance and feel. Functional features are also provided as hereinafter described.

### BACKGROUND OF THE INVENTION

Textile finishing with emulsions is known in the art; for example, silicone emulsions are used to impart softness and water repellency. See, U.S. Pat. No. 4,909,267 to Ichinohe et al., entitled Method for the Finishing Treatment of Fabric Materials; and U.S. Pat. No. 6,001,422 to Hirai et al., entitled Method for Finishing Treatment of a Fabric Material. Functional finishes are used for flame retardancy, anti-static properties, soil-resistance and so forth. See, Functional Finishes, Part B, Handbook of Fiber Science and Technology: Volume II, Chemical Processing of Fibers and Fabrics, Menachem Lewin et al., Marcel Dekker, Inc. (New York and Basel 1984). A major drawback of silicone compositions have poor fastness qualities and tend to yellow.

Vinyl acetate emulsions and polyvinyl alcohols, on the other hand, have been largely overlooked as potential finishing agents for textiles; rather, these products are used mostly as adhesives for wood, plastic and the like, or as binders for nonwovens.

U.S. Pat. No. 7,056,847 to Walker et al. discloses vinyl acetate-ethylene self-crosslinking copolymer emulsions useful as binders for nonwovens. Typically, the binders are applied at add-ons of 20% by weight of goods or so to provide strength in order to render a nonwoven web self-sustaining. The polymer is also reported to be useful as a treatment for woven fabrics. See, Col. 7, lines 13-20. See also, U.S. Pat. No. 3,380,854 to Lindemann et al., which discloses vinyl acetate/ethylene/N-methylol acrylamide binders for nonwovens.

Vinyl acetate emulsions have also been used in water-repellant coatings, backing for fabrics, as an ironing aid for synthetic fabrics to restore feel to a fabric and as a means to provide hydrophobic particles to the surface of textiles.

British Specification No. 1 427 488 discloses water-repellant coatings for cotton, polyesters, polyamides and cotton/polyester blends. The coatings include acrylic terpolymers and vinyl acetate/ethylene/N-methylol acrylamide terpolymers in specified ratios with wax. Application is by blade coating. U.S. Pat. No. 3,440,200 to Lindemann et al. discloses a vinyl acetate/ethylene/glycidyl acrylate latex use as a fabric coating. The latex is applied at a solids level of about 10% concentration, with an add-on of about 18%. See, Col. 8, lines 29-45.

Bulgarian Publication No. BG51888 discloses compositions for spraying, blading, rolling or printing onto textiles to improve softness, washing properties and hydrophilicity. The compositions are water dispersions or foams which include urea, various latexes such as vinyl acetate-ethylene as well as fillers and so forth. Generally, the latex is present in an amount of about 5% and more of the aqueous composition.

U.S. Pat. No. 3,567,498 to Rafferty et al. discloses a method of treating a fabric to restore tactile properties including applying an ironing lubricant and up to 3% of a resin selected from copolymers of ethylene and vinyl acetate, copolymers of butyl acrylate and acrylamide and copolymers of polybutyl acrylate and acrylic acid. The copolymers are applied at a concentration in the range of 0.5-5% solids. See, Col. 3, lines 46-66: “Whether or not the liquid treating composition is made up in the form of a concentrated or diluted dispersion, it should be applied to the fabric from a water dispersion in which the resin is present in a range from about 0.5 to 5 percent solids by weight with a preferred range being from about 0.5 to 3 percent. The optimum range will depend upon the fabric, the method by which the liquid is applied, and the finish desired on the treated fabric. For example, if the application is to be a cotton-Dacron (polyester) blend by dipping, a 2 percent by weight dispersion of the copolymer of ethylene and vinyl acetate has been found to be satisfactory. Although subsequent launderings after treatment remove a portion of the resin, it apparently does not remove all of it so that the effect is to build up a small amount of resin in the fabric. However, the buildup is very slight; and the treatment may be used after each laundering. It may, however, be used only periodically. Normally, the amount of resin present in a treated fabric should not be above about 3% by fabric weight, while a preferred minimum is from 0.5 to 1% by weight.” From the foregoing, it is apparent that the post-consumer treatment disclosed is not durable to a substantial degree and does not provide unique comfort or functional properties as are described herein.

United States Patent Application Publication No. 2008/0040866 of Moore et al. discloses fabrics treated with hydrophobic particles, including emulsions. Polytetrafluoroethylene, polyvinyl acetate, and polyvinyl acetate/acrylic copolymer dispersions are used to treat textiles, including yarns, fabrics, linens, and articles of clothing. The use of dispersions creates textiles with a discontinuous treatment of discrete individual hydrophobic particles applied to the surface.

Polyvinyl alcohol resins are known to be useful as warp yarn sizing; however, the sizing is stripped from a woven fabric prior to finishing.

It has been unexpectedly found in accordance with the present invention that polyvinyl acetate emulsions and polyvinyl alcohol resins can be used to finish apparel fabrics and provide desirable comfort-related properties such as compression recovery, better slip and so forth as well as functional characteristics.

### SUMMARY OF THE INVENTION

The present invention is directed generally to textile finishing with vinyl acetate emulsions and/or polyvinyl alcohols suitable to impart comfort-related attributes to apparel or enhance functional features. Comfort-related properties include: weight, compression, bending, surface, shear and tensile as is discussed hereinafter. Functional properties which are also optionally enhanced include: hydrophobicity, hypoallergenic properties, linting, anti-pilling effect, wickability, softness, luster or lack thereof, color, odor masking, water repellency, flame retardancy, crockfastness, colorfastness, comfort, strength properties (tensile and burst), anti-rip, barrier properties, novel cross dyeing/tinting of blends, novel union dyeing of blends.

The novel approach to textile finishing of the invention allows for unique visual effects, increased synthetic fiber usage and more efficient processing and manufacture of apparel. For example, the invention provides: improved functionality of 100% synthetic or 100% natural fiber wovens or blended wovens; with a blended formulation of PVOH and emulsion creates novel visual effects; allows for higher percentage polyester component (>50% polyester) in a polyester/cotton blended woven fabric to have hand/feel properties of a cotton majority (>50% cotton) blend woven fabric, among other advantages. Thus, the invention allows for stronger woven fabrics that remain comfortable. Further, the invention enables new coloration methods: for example, having non-polar emulsions formulated with disperse or reactive dyestuffs in a batch dyebath exhaust only to the non-polar portion of a woven blend, such as polyester. This allows for the skipping of the package dyeing segment of the value chain. A current manufacturing process is yarn spinning→package/yarn dyeing of polyester→weaving→thermosol dyeing of poly/cotton fabric→cut and sew→garment washing; however, with the invention, the process can be simplified to yarn spinning→weaving→dyeing→cut and sew→garment washing.

It has been unexpectedly found in accordance with the present invention that polyvinyl acetate emulsions, including vinyl acetate/ethylene copolymers, vinyl acetate acrylic, acrylic emulsions, polyvinyl alcohols, polyvinyl alcohol vinyl formamide copolymers and polyvinyl alcohol vinyl amine copolymers and the like have a surprising high affinity for a wide variety of textile fibers as is reflected in the substantivity of the resins in the finishing liquors and strike rate or add-on rate to the finished textiles. Without intending to be bound by theory, it is believed that in a preferred embodiment of the invention, i.e., polyvinyl acetate and/or polyvinyl alcohol or polyvinyl alcohol copolymers exhaust from a finishing liquor to the fiber surface, then penetrate the fiber, followed by migration into the body of the fiber followed by chemical or physical fixation to the fiber.

Even water-soluble resins applied in accordance with the invention surprisingly resist removal by ordinary post-consumer laundering.

The finishing operation in accordance with the present invention may be carried out in the production process at any suitable stage, for example before dyeing of the textile, during dyeing of the textile, or after dyeing of the textile, concurrently with post-dyeing tinting, for example, if so desired.

### BRIEF DESCRIPTION OF THE DRAWINGS

The invention is described in detail below with reference to the various Figures. In the Figures:

FIG. 1 is a chart illustrating unique properties imparted by emulsion-treatment in accordance with the invention;

FIGS. 2-6 are respectively photographs of a compression tester, a bending tester, a surface tester, a shear tester and a tensile tester; and

FIG. 7 is another chart illustrating unique properties imparted by emulsion treatment in accordance with the invention.

### DETAILED DESCRIPTION

The invention is described below with reference to numerous embodiments. Such discussion is for purposes of illustration only. Modifications to particular examples within the spirit and scope of the present invention set forth in the appended claims, will be readily apparent to one of skill in the art.

Terminology used herein is given its ordinary meaning consistent with the exemplary definitions set forth below; %, percent and like terminology refers to weight percent and so forth. “Add-on” refers to solids added to the textile and the % add-on is on a dry basis.

In one illustrative aspect the invention comprises a method of finishing a textile comprising the steps of: (a) preparing an aqueous finishing liquor comprising from 0.05 wt. % solids to 65 wt. % solids of a finishing resin selected from the group comprising: vinyl acetate emulsion resins, including copolymers such as vinyl acetate ethylene emulsions or vinyl acetate acrylic emulsions, acrylic emulsions, polyvinyl alcohol resins, including polyvinyl alcohol vinyl formamide copolymers, vinyl amine copolymers, sulfonic acid functionalized polyvinyl alcohol resins, modified polyvinyl alcohol resins generally; and mixtures thereof; (b) saturating the textile with the finishing liquor to incorporate the liquor into the textile so as to provide a wetted textile; (c) processing the wetted textile at elevated temperature under conditions which are controlled such that the finishing resin is inter-associated with the fibers of the textile, wherein the finishing resin is durably and uniformly inter-associated with the textile fiber surfaces at an add-on level of from 0.05 wt. % to less than 65 wt. % and is operative to alter at least one comfort-related property of the textile.

Aqueous finishing liquor, as used herein, refers to a water soluble solution which is comprised of between 0.05 wt. % solids to 65 wt. % solids of a finishing resin. The aqueous finishing liquor may further comprise an additional resin selected from cellulosics and synthetic latexes such as SBR latex. Additionally, the aqueous finishing liquor may further comprise external crosslinkers, wetting agents, anti-foam agents, softening agents, compatibilizers, starches, chelating agents, fixing agents, buffers, coating agents, binders, latexes, release finishes, enzymes, flame retardants, optical brightners, durable press agents, anti-microbial agents, uv-stabilizers and combinations thereof. In another embodiment, the finishing liquor comprises from 0.05 wt. % solids to 50 wt. % solids of the finishing resin, from 0.05 wt. % solids to 40 wt. % solids of the finishing resin, from 0.05 wt. % solids to 30 wt. % solids of the finishing resin, from 0.05 wt. % solids to 20 wt. % solids of the finishing resin, from 0.05 wt. % solids to 10 wt. % solids of the finishing resin, from 0.05 wt. % solids to 5 wt. % solids of the finishing resin, from 0.1 wt. % solids to 5 wt. % solids of the finishing resin, from 0.1 wt. % solids to 2.5 wt. % solids of the finishing resin, or from 0.1 wt. % solids to 1 wt. % solids of the finishing resin in some preferred embodiments.

Finishing resin, as used herein, refers to a material selected from the group comprising: vinyl acetate emulsion resins, including copolymers such as vinyl acetate ethylene emulsions, vinyl acetate acrylics, acrylic emulsions, polyvinyl alcohols, polyvinyl alcohol resins, including polyvinyl alcohol vinyl formamide copolymers, vinyl amine copolymers, sulfonic acid functionalized polyvinyl alcohol resins, modified polyvinyl alcohol resins (i.e. hydrophobically modified) generally, an ultra-violet light curable composition; and mixtures thereof.

“Textiles” and like terminology refers to yarns, fabrics, sewing threads, finished garments and so forth. “Yarns” include yarns of all fiber types, natural or synthetic. Natural yarns include cotton, bast, wool, silk, animal hair such as angora or mohair. Synthetic yarns include polyester, acrylic, polyamides, rayon, acetate, triacetate and so forth.

“Yarn” includes blended yarns as well as 100% single component yarns, for example, 40% silk/60% wool yarn, 50% cotton/45% polyester/5% spandex, or 50% cotton/50% polyester. The invention is also directed to monofilament synthetic yarns and other extruded filament yarns. Fabrics may be knit or woven fabrics made of the fibrous materials described above. Garments may be apparel and industrial garments. This is the finished cut and sewn version of the yarns and fabrics described herein. Included also are industrial fabrics which include laminated multi-layer components, modular garments (such as military garments that have different sleeve material than the torso area, for example) as well as home goods such as linens, drapery, upholstery (automotive, boating, airline included) made of the materials described in the foregoing.

Thus, the kinds of fibers forming a fabric material and/or the textile to which the inventive method is applicable are not particularly limitative including not only natural fibers such as cotton, silk, linen, wool, angora and mohair, but also synthetic and semi-synthetic fibers such as polyester fibers, aramid fibers, polyamides, acrylic (acrylonitrile) fibers, spandexes, rayons, Tencel and cellulose acetate fibers. So also, blends of synthetic and natural fibers are contemplated. The form of blend is also not limitative; the fabric may be a woven fabric including synthetic yarns such as 100% polyester yarn and natural yarns such as 100% cotton yarns or the yarn itself may be a blended yarn with both polyester and cotton staple fibers. The form of the textile material, also not limitative, includes woven fabrics, knit fabrics and non-woven fabrics as well as staples, filaments, waddings, tows and sewing threads.

In accordance with the invention, textiles may be treated with emulsion copolymer by any suitable technique. Yarn can be treated with saturating liquors (called “pad baths”) with a nip roll squeeze after each bath saturation. The solution is optionally mixed with water for introduction to any continuous pad bath. Yarn can also be treated in “package” form with the solution. Woven goods can be pad bath finished in continuous stenter (open width) frames or with batch processes such as, piece dyeing, jet, beck, jigger or paddle machines. Knit goods are processed in the same machinery (both continuous and batch) as woven, just under different conditions. For garments, industrial garment washing machines may be used. Optional application methods include manual processes such as spraying or manual wet add-on techniques. Likewise, the textile can be treated during dyeing or washing. Dyeing and fabric washing methods are disclosed in U.S. Pat. Nos. 7,201,780 to Schoots and 6,663,677 to Schoots et al., the disclosures of which are incorporated herein by reference.

In one preferred embodiment, the inventive textile treatment method may be practiced by exhaustion processing; that is, batchwise, immersed in dilute aqueous media. In another preferred embodiment, textiles are treated on a continuous apparatus for immersion treating textiles, as is disclosed, for example, in U.S. Pat. No. 4,920,621 to Metzen, entitled Apparatus and Method for Finishing a Traveling Textile Fabric Web, the disclosure of which is incorporated herein by reference.

Regardless of the method of application selected, application and processing conditions must be selected such that the textile has a uniform distribution of finishing composition that is intimately and durably inter-associated with the textile such that the treatment is durable and effective to substantially modify or enhance comfort related properties of the textile and optionally one or more functional properties as well. Typically, temperatures in excess of 140° F. (60° C.) are employed during application and a higher temperature cure is preferred for self-crosslinking compositions. Suitably, application and processing temperatures are from 125° F. (50° C.) to 450° F. (232° C.) and are controlled such that the emulsion particles or polyvinyl alcohol employed conforms to the morphology of the fiber surfaces in the form of a film, for example, or a film-like structure inter-associated with the fiber surface. A processing temperature range of 140° F. (60° C.) to 400° F. (204° C.) is preferred. In another embodiment, a processing temperature range of 150° F. (65° C.) to 400° F. (204° C.) is preferred. In still another embodiment, a processing temperature range of 212° F. (100° C.) to 400° F. (204° C.) is preferred.

The inventive methods and products do not alter the basic character of the treated textile, i.e., do not radically change body conforming properties of the apparel or wearability characteristics, rather, the treatment modifies or enhances the properties within acceptable parameters for apparel. This is accomplished by durably and uniformly inter-associating the finishing resin with the textile surfaces. To this end, the add-on of the finishing resin (i.e. emulsion resin, polyvinyl alcohol, etc) is generally in the range of 0.05 wt. % to less than 65% by weight of the finished textile, from 0.05 wt. % to 50 wt. %, from 0.05 wt. % to 40 wt. %, from 0.05 wt. % to 30 wt. %, from 0.05 wt. % to 20 wt. %, from 0.05 wt. % to 10 wt. %, from 0.05 wt. % to 5 wt. %, from 0.1 wt. % to 5 wt. %, from 0.1 wt. % to 2.5 M. %, or from 0.1 wt. % to 1 wt. % in some preferred embodiments. The comfort related property of a textile, as used herein, refers to the following: weight, compression, bending, surface, shear and tensile.

In one embodiment of the above method, the finishing resin is inter-associated with the textile so as to improve the textile's durability to laundering. In another embodiment of the above method, the finishing resin is a self-crosslinking vinyl acetate ethylene emulsion resin and the textile is processed at a temperature above 250° F. and less than 450° F. in order to cure the resin. In still another embodiment of the above method, the textile is saturated by immersion in a bath of the finishing liquor after which the finishing liquor is removed from the textile by compressing the wetted structure with squeeze rolls. In yet another embodiment of the above method, the textile is saturated by immersion in a bath of the finishing liquor at a temperature selected from the group: in the range of 125° F. (51° C.) to 450° F. (232° C.)., in the range of 140° F. (60° C.) to 450° F. (232° C.)., or in the range of 200° F. (93° C.) to 450° F. (232° C.).

The method described above may further comprise the step of treating the fabric with infra-red radiation and/or microwaves. In another embodiment, the method described above may include a finishing resin comprising an ultra-violet light curable composition and further comprise the step of irradiating the wetted fabric with an ultra-violet light.

The method described above may according to claim 1 wherein the finishing liquor is operative to accomplish a variety of tasks which include: impart no detrimental color change and/or improve the CIEL*a*b* value of textile; impart appearance properties, in particular improving luster of textile; improve the feel of the textile, in particular the thickness; impart moisture transport properties to the textile; impart hand to the textile, in particular smoothness; impart strength properties to the textile, such as but not limited to shear, burst, and tensile strength; impart heat transfer properties to the textile; impart durability and longevity through improvement of compression and recovery of compression properties of the textile; impart bending properties to the textile; impart no detrimental effect on dimensional stability of the textile; impart no detrimental effect or improves on ink receptivity of textile; or combinations thereof.

The copolymer emulsion used to provide unique properties may be selected form a variety of vinyl acetate emulsion resin compositions such as self-crosslinking vinyl acetate ethylene emulsion resin, vinyl acetate acrylics, acrylic emulsions, vinyl acetate/vinyl versatate esters and so forth as described herein. The invention contemplates combinations and blends of vinyl acetate ethylene resins with polyvinylacetate, polyvinyl alcohol, as well as homopolymers and copolymers. Exemplary compositions include: vinyl acetate ethylene emulsions, vinyl acrylic emulsions, both of which may be self-crosslinking, non-crosslinking with a Tg of from −50° C. to +70° C. Some preferred monomers include vinyl acetate, ethylene and vinyl acrylates. Suitable vinyl acetate/ethylene self-crosslinking emulsions are those of the class described in U.S. Pat. No. 7,056,847 to Walker et al., while suitable self-crosslinking vinyl acetate emulsions are those of the class described in United States Patent Application Publication No. US2007/0184732 of Lunsford et al, the disclosures of which are incorporated herein by reference.

The emulsions employed in connection with the invention may also be of the class without self-crosslinking monomers. See, for example, U.S. Pat. No. 6,001,916, to Walker et al., entitled “Ultra High Solids Vinyl Acetate-Ethylene and vinyl Acetate Homopolymer Emulsions”, the disclosure of which is hereby incorporated by reference.

It will be appreciated from the foregoing that besides vinyl acetate, additional monomers such as alkyl acrylates or α-olefin monomers and/or neoalkanoic acid vinyl esters are also provided in the polyvinyl acetate emulsion compositions employed. Examples of suitable α-olefin monomers include ethylene, propylene, α-butylene, α-pentylene, α-hexylene, α-octylene and so forth. Vinyl esters of neoalkanoic acids have the following general structure:

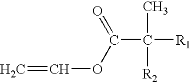

where R₁ and R₂ are alkyl groups which together may typically collectively contain from about 6-8 carbon atoms. Veo Va™ neoalkanoic vinyl esters are available from Hexion Specialty Chemicals of Columbus, Ohio. In VeoVa™ 9, R₁ and R₂ together contain about 6 carbon atoms. In VeoVa™ 10, R₁ and R₂ together contain about 7 carbon atoms. In VeoVa™ 11, R₁ and R₂ together contain about 8 carbon atoms. Inclusion of neoalkanoic acid vinyl esters in polymer systems introduces hydrophobicity to the polymer that can provide hydrocarbon solubility or adhesion to low-energy surfaces and also add steric bulk to the polymer providing it with hydrolytic stability.

Representative of esters of ethylenically unsaturated carboxylic acids which may also be used in vinyl acrylics include alkyl acrylates and methacrylates wherein the alkyl group contains 1-12 carbon atoms and esters of such acids as butenoic, maleic, fumaric, itaconic and the like. Representative of other esters which have an ethylenic unsaturation and are preferred include vinyl formate, vinyl versatate, and the like. The alkyl acrylates that can be used to prepare the acrylic ester latex emulsions include alkyl acrylates and alkyl methacrylates containing 1 to 12, preferably 1 to 10 carbon atoms in the alkyl group. The polymer backbone in the acrylic ester latexes can be either hydrophilic or hydrophobic and it can comprise polymerized soft monomers and/or hard monomers. The soft and hard monomers are monomers which, when polymerized, produce soft or hard polymers, or polymers in between. Preferred soft acrylic ester monomers are selected from alkyl acrylates containing 2 to 8 carbon atoms in the alkyl group and include ethyl acrylate, propyl acrylate, n-butyl acrylate, and 2-ethylhexyl acrylate. The hard acrylic ester monomers are selected from alkyl methacrylates containing up to 3 carbon atoms in the alkyl group and from non-acrylic monomers such as styrene and substituted styrenes, acrylonitrile, vinylchloride, and generally any compatible monomer the homopolymer of which has a Tg above 50° C. Preferred acrylic ester monomers are selected from alkyl methacrylates containing 1 to 12 carbon atoms in the alkyl group, especially methyl methacrylate. See U.S. Pat. No. 5,021,529 to Garrett.

Further monomers copolymerizable with vinyl esters are ethylenically unsaturated, ionic monomers, for example compounds which bear at least one carboxylic acid, sulfonic acid, phosphoric acid or phosphonic acid group directly adjacent to the double bond unit, or else are bonded thereto via a spacer. Examples include:

α,β-unsaturated C₃-C₈-monocarboxylic acids, α,β-unsaturated C₅-C₈-dicarboxylic acids and anhydrides thereof, and monoesters of α,β-unsaturated C₄-C₈-dicarboxylic acids.

Preference is given to unsaturated monocarboxylic acids, for example acrylic acid, methacrylic acid, and crotonic acid and the anhydrides thereof; unsaturated dicarboxylic acids, for example maleic acid, fumaric acid, itaconic acid and citraconic acid and the monoesters thereof with C₁-C₁₂-alkanols such as monomethyl maleate and mono-n-butyl maleate. Further preferred ethylenically unsaturated ionic monomers are ethylenically unsaturated sulfonic acids, for example vinylsulfonic acid, 2-acrylamido-2-methylpropanesulfonic acid, 2-acryloyloxy- and 2-methacryloyloxyethanesulfonic acid, 3-acryloyloxy- and 3-methacryloyloxypropanesulfonic acid and vinylbenzenesulfonic acid, and ethylenically unsaturated phosphoric acids, for example vinylphosphonic acid.

In addition, as well as the acids mentioned, it is also possible to use the salts thereof, preferably the alkali metal salts thereof or the ammonium salts thereof and especially the sodium salts thereof, for example the sodium salts of vinylsulfonic acid and of 2-acrylamidopropanesulfonic acid.

The ethylenically unsaturated free acids mentioned are present in aqueous solution at pH 11 predominantly in the form of their conjugate bases in anionic form and can, like the salts mentioned, be referred to as anionic monomers.

Preferred polymers include emulsion interpolymers enumerated above, however the optional inclusion or substitution of other still other comonomers is contemplated. Other potentially useful comonomers include 1-heptene, butadiene, hexadiene, isoprene, styrene, methyl styrene, divinyl benzene and the like. Representative of still other ethylenically unsaturated monomers include halogenated monomers such as vinyl chloride, vinylidene chloride, chloroprene, chlorostyrene and the like.

Postcrosslinking comonomers (referred to in the art sometimes as self-crosslinking monomers) are included in many embodiments, that is where a self-crosslinking resin is used. These monomers include acrylamidoglycolic acid (AGA), methyl methacrylamidoglycolate (MMAG), N-methylolacrylamide (NMA), N-methylolmethacrylamide (NMMA), allyl-N-methylolcarbamate, alkyl ethers such as the isobutoxy ethers or esters of N-methylolacrylamide, of N-methylolmethacrylamide and of allyl N-methylolcarbamate.

Also suitable are epoxide-functional comonomers such as glycidyl methacrylate and glycidyl acrylate. Further examples are silicon-functional comonomers such as acryloxy-propyltri(alkoxy)silanes and methacryloxypropyltri(alkoxy)silanes, vinyltrialkoxysilanes and vinylmethyldialkoxysilanes, with alkoxy groups which can be present being, for example, methoxy, ethoxy and ethoxypropylene glycol ether radicals. Mention may also be made of useful monomers having hydroxy or CO groups, for example, hydroxyalkyl meth acrylates and acrylates such as hydroxyethyl, hydroxypropyl or hydroxybutyl acrylate or methacrylate and also compounds such as diacetoneacrylamide and acetylacetoxyethyl acrylate or methacrylate. See United States Patent Application Publication No. 2007/0112117 to Weitzel.

Crosslinkers that can be used in conjunction with the present invention are also precrosslinking comonomers such as multiply ethylenically unsaturated comonomers, for example divinyl adipate, diallyl maleate, allyl methacrylate or triallyl cyanurate and the like.

External crosslinkers may also be used in the finishing liquor as noted hereinafter.

The vinyl acetate polymer or copolymers used may be made by a variety of techniques by which vinyl acetate polymers are made including by bulk, solution, suspension and emulsion processes as is described in the Kirk-Othmer Encyclopedia of Chemical Technology, 4^{th} Ed Vol. 24, pp. 954-963 (Wiley 1996), the disclosure of which is incorporated herein by reference. The preparation of the inventive compositions can be carried out using continuous or discontinuous processes of free-radical emulsion polymerization. The polymerization may be conducted with the assistance of customary reaction vessels such as loop or stirred reactors. Preference is given to using discontinuous processes such as batch, combined batch/feed stream, pure feed stream processes or feed stream processes onto nucleating particles.

In these processes, water-soluble and/or oil-soluble initiator systems such as peroxodisulfates, azo compounds, hydrogen peroxide, organic hydroperoxides or dibenzoyl peroxide are employed. These may be used either by themselves or in combination with reducing compounds such as Fe(II) salts, sodium pyrosulfite, sodium hydrogen sulfite, sodium sulfite, sodium dithionite, sodium formaldehyde-sulfoxylate, ascorbic acid, as a redox catalyst system. The emulsifiers, and/or where appropriate, protective colloids, additives and/or auxiliaries may be added before, during or after the polymerization. Examples of emulsifiers include alkyl aryl polyglycol ethers and alkyl polyglycol ethers each preferably having from 8 to 50 mol of ethylene oxide units per molecule, block copolymers of ethylene oxide with propylene oxide, alkylsulfonates or alkyarylsulfonates, alkyl sulfates, alkyl and aryl ether sulfates and phosphates each having preferably from 8 to 18 carbon atoms in the lipophilic part and up to 50 ethylene oxide or propylene oxide units in the hydrophilic part, and also monoesters or diesters of sulfosuccinic acid or alkylphenols each having preferably from 8 to 18 carbon atoms in the alkyl radical. A preferred type of emulsifier does not contain linear alkyl phenol units in the lipophilic part.

With respect to polyvinyl alcohol compositions, any suitable polyvinyl alcohol having a Mw of from 10,000-250,000 may be used. The polyvinyl alcohols may have any suitable degree of hydrolysis and Mw and may optionally include comonomers such as vinylamine and vinyl formamide comonomers or 2-acrylamido-2-methylpropyl sulfonic acid (AMPS) comonomers. Descriptions of suitable polyvinyl alcohol vinyl formamide copolymers, polyvinyl alcohol vinyl amine copolymers and polyvinyl alcohol amps copolymers are found in U.S. Pat. No. 5,300,566 to Pinschmidt et al; U.S. Pat. No. 5,591,799 to Bott et al.; as well as U.S. Pat. No. 6,818,709 to Vicari et al., the disclosures of which are incorporated herein by reference.

Generally speaking, the polyvinyl alcohol resins employed may be based on vinyl acetate homopolymer or copolymers of vinyl acetate with any suitable comonomer and/or blends thereof. Methods of producing polyvinyl acetate-polyvinyl alcohol polymers and copolymers are known to those skilled in the art. U.S. Pat. Nos. 1,676,156; 1,971,951; and 2,109,883, as well as various literature references describe these types of polymers and their preparation. These polymers may be functionalized as is known in the art by appropriate incorporation of suitable comonomers. Among the literature references are “Vinyl Polymerization”, Vol. 1, Part 1, by Ham, published by Marcel Dekker, Inc., (1967) and “Preparative Methods of Polymer Chemistry”, by Sorenson and Campbell, published by Interscience Publishers, Inc., New York (1961).

Modified polyvinyl alcohols may likewise be used, for example: hydrophobically modified PVOH, i.e., VEOVA; PVOH-coPYR (pyridinyl); PVOH-co-COOH (Itaconic Acid); PVOH methyl methacrylate; and PVOH-DAE. See, United States Patent Application Publication No. US 2007/0160780, published Jul. 12, 2007, of Renz et al., entitled “Poly(Vinyl Alcohol)-Co-Poly(N-Vinyl Formamide) Copolymers” and U.S. Pat. No. 5,567,768, issued Oct. 22, 1996, to Amici et al., entitled “Poly(Vinyl Alcohol) Blends”, the disclosures of which are hereby incorporated by reference.

Modified polyvinyl acetates or polyvinyl alcohols with functional groups such as keto-ester groups may also be used. See U.S. Pat. No. 5,719,231, issued Feb. 17, 1998, to Famili, entitled “Process for Manufacturing Polyvinyl Alcohol Polymers Containing Acetoacetic Ester Groups”, the disclosure of which is hereby incorporated by reference. In general, polyvinyl alcohols useful in connection with this invention may have the following structure:

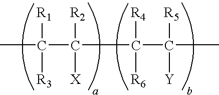

Wherein R1-R6 can be any of the following in combination or aggregation (the same, different or combinations thereof): Hydrogen; C₁-C₄ alkyl; C₁-C₄ alkoxy; Acetate; Hydroxyl; Carbocyclic; Heterocyclic; and mixtures thereof. X,Y can be the same or different any may be selected from the group comprising: Hydroxyl; Acetate; Amine; Amide; Sulfonate; Carboxylate; heterocyclic and mixtures thereof.

External crosslinkers are also optionally used in the finishing liquor, for example, epoxysilanes, bisulfites, ammonium salts, zirconium salts, glyoxals, DMDHEU; and boric acid. “DMDHEU” refers to dimethyloldihydroxyethyleurea.

Suitable crosslinkers which may be added to the finishing liquor also include phenol formaldehyde resins, resorcinol formaldehyde resins, melamine formaldehyde resins, hydroxymethylsubstituted imidazolidinones or thioimidazolidinones, hydroxymethyl substituted pyrimidinones or hydroxymethyl substituted triazinones or glycoluriles or their self condensation products are suitable or mixed condensates from two or more of the compounds mentioned, or a mixture from two or more of the compounds mentioned. Exemplarily mentioned is for this 1,3-bis(hydroxymethyl)-4-methoxy-4,5,5-trimethyl-2-Imidazolidinon, N,N′ Dimethylol-4-methoxy-5,5 dimethylpropyleneurea, N,N<I>,N″,N<I>″-Tetrakis (hydroxymethyl) glycoluril, 4,5-Dihydroxyl-3-bis(methoxymethyl)-2-imidazolidinon, 4,5-Dihydroxy-1,3-bis (hydroxymethyl)-imidazolidin-2-on, Tetrahydro-1,3-bis(hydroxymethyl)-4-methoxy-5,5-dimethylpyrimidin-2 (1H)-on, 4,5-Dihydroxy 1,3-dimethylol-2-imidazolidinon, 4,5-Dihydroxyl, 3-dimethyl-2-imidazolidinon, Tetrahydro-1,3-bis(hydroxymethyl)-4-hydroxy-5,5 dimethyl (1H)-pyrimidin-2 on, Tetrahydro-1,3-bis(hydroxymethyl)-4-alkoxy-5,5-dimethyl (1H)-pyrimidin-2 on and N,N′,N″,N′″-Tetrakis (hydroxymethyl) glycoluril. Preferred crosslinkers are likewise disclosed in EP-A 1,505,085 (the disclosure of which is incorporated herein by reference) that is, partial or complete etherified resins on base of methylolierter ethyl urea, propylene urea, glyoxaldiureas, malondialdehydureas or their combinations. Other Polyaldehyde represents a further excellent suitable group of external crosslinking agents like aromatic hydrocarbons with two to six aldehyde groups, dialdehyde starches or other water-soluble polyaldehydes, and likewise at least partially masked polyaldehydes described in EP-A-686,682, the disclosure of which is incorporated herein by reference.

Suitable catalyst and accelerators include Brönsted acids have a pKs value of <2,5, for example hydrochloric acid, sulfuric acid, nitric acid, perchloric acid, p-toluenesulfonic acid, in particular phosphoric acid. When Lewis acids are used, suitable ones are particularly the acidic salts of complexable metal ions, in particular aluminum chloride, aluminum nitrate, zirkonoxychloride and titanium sulfate, magnesium chloride or mixtures thereof, in particular the acid salts with multi-valued complexable cations, as they are for example listed in DE-B 22 61 402, DEK 26 20 738 and DE-A 3942 628; the disclosures of which are hereby incorporated by reference.

The instant invention also discloses a method of concurrently dyeing or tinting and finishing a textile which is a blend of natural and synthetic fiber, the method comprising the steps of: (a) preparing an aqueous finishing liquor comprising from 0.05 wt. % solids to 40 wt. % solids of a finishing resin selected from the group consisting of: vinyl acetate emulsion resins, including copolymers such as vinyl acetate ethylene emulsions or vinyl acetate acrylic emulsions, polyvinyl alcohol resins, including polyvinyl alcohol vinyl formamide copolymers, vinyl amine copolymers, sulfonic acid functionalized polyvinyl alcohol resins, modified polyvinyl alcohol resins generally; and mixtures thereof, as well as at least one dye being a first dye; (b) saturating the blended textile with the finishing liquor to incorporate the liquor into the textile so as to provide a wetted textile; and (c) processing the wetted textile at an elevated temperature under conditions which are controlled such that the finishing resin is inter-associated with the fibers of the textile and the dye is affixed to the textile; wherein the finishing resin is durably and uniformly inter-associated with the textile fiber surfaces at an add-on level of from 0.05 wt. % to less than 40 wt. % and is operative to alter at least one comfort-related property of the textile.

In one embodiment of the above method, the fabric is a blend of polyester yarn and cotton yarn. In another embodiment of the above method, the finishing liquor contains a second dye. In still another embodiment of the above method, the first dye is selectively applied to the natural fiber, and the second dye is selectively applied to the synthetic fiber or vice versa.

The instant invention also discloses a textile finished with a finishing resin selected from: vinyl acetate emulsion resins, including copolymers such as vinyl acetate ethylene emulsions or vinyl acetate acrylic emulsions, acrylic emulsions, polyvinyl alcohol resins, including polyvinyl alcohol vinyl formamide copolymers, vinyl amine copolymers, sulfonic acid functionalized polyvinyl alcohol resins, modified polyvinyl alcohol resins generally; and mixtures thereof at an add-on level of from 0.05 wt. % to less than 65 wt % wherein the finishing resin is durably and uniformly inter-associated with the textile fiber surfaces and is operative to alter at least one comfort-related property of the textile.

In one embodiment of the above finished textile, the finishing resin comprises a polyvinyl alcohol having a Mw of from 1,000 to 1,000,000. In another embodiment of the above finished textile, the finishing resin comprises a polyvinyl alcohol having a Mw of from 10,000 to 500,000. In still another embodiment of the above finished textile, the textile comprises cotton and the finishing resin comprises a polyvinyl alcohol vinyl formamide copolymer or a polyvinyl alcohol vinyl amine copolymer. In still another embodiment of the above finished textile, the finished textile further comprises a latex or cellulosic resin. In yet another embodiment of the above finished textile, the finishing resin is durably and uniformly inter-associated with the fibers in film-form. In still another embodiment of the above finished textile, the finishing resin is durably and uniformly inter-associated with the textile surfaces at an add-on level of from 0.1 wt. % to 55 wt. %., 0.05 wt. % to less than 50 wt. %, from 0.1 wt. % to 45 wt. %, 0.05 wt. % to less than 40 wt. %, 0.05 wt. % to less than 30 wt. %, 0.05 wt. % to less than 20 wt. %, or 0.05 wt. % to less than 15 wt. %.

In another embodiment of the above finished textile, wherein the textile is a conformable fabric with an add-on of finishing resin of from 10 wt. % to 50 wt. % wherein the fabric is suitable for masking anatomical detail when worn. In still another embodiment of the above finished textile, wherein the textile is a synthetic/natural fiber fabric provided with an add-on of from 5 wt. % to 50 wt. % that is capable of providing a sueded/textured surface upon brushing or sanding without further mechanical processing.

The instant invention also discloses a textile finished with a finishing resin selected from: vinyl acetate emulsion resins, including copolymers such as vinyl acetate ethylene emulsions or vinyl acetate acrylic emulsions, polyvinyl alcohol resins, including polyvinyl alcohol vinyl formamide copolymers, vinyl amine copolymers, sulfonic acid functionalized polyvinyl alcohol resins, modified polyvinyl alcohol resins generally; and mixtures thereof at an add-on level of from 0.05 wt. % to less than 10 wt. % wherein the finishing resin is durably and uniformly inter-associated with the textile fiber surfaces and is operative to alter at least one comfort-related property of the textile. In another embodiment of the above finished textile, the finishing resin is durably and uniformly inter-associated with the textile surfaces at an add-on level of from 0.1 wt. % to 5 wt. %. In still another embodiment of the above finished textile, the finishing resin is durably and uniformly inter-associated with the textile surfaces at an add-on level of from 0.1 wt. % to 2.5 wt. %. In yet another embodiment, the finishing resin is durably and uniformly inter-associated with the textile surfaces at an add-on level of from 0.1 wt. % to 1 wt. %. In still another embodiment, the finishing resin comprises a polyvinyl acetate.

In yet another embodiment, the finishing resin comprises a polyvinyl alcohol.

One embodiment of the instant invention focuses on the fabric finishing of intimate apparel. One type of intimate apparel is the brassiere (bra) which is designed to cover, support and/or shaped the breasts of the wearer. While the instant invention may be applied to all parts of a bra, the focus of this embodiment will be on the cups, wings and other fabric based parts of the bra. In general, bra cups are a multi-layered, laminated material comprised of an outer layer which surrounds an inner layer. The outer layer is comprised of a knit fabric made from either synthetic (polyester, nylon, rayon and blends of elastane) or natural (cotton, wool, silk) yarns. The inner layer is most often, but not exclusively, comprised of a foam (i.e. aliphatic or aromatic polyurethane foam). The inner and outer layers are combined and molded to a desired shape (the cup) generally using high temperatures and pressure. It is known that the conditions of the molding process are the origin of many quality problems with bras, including the loss of product integrity resulting in a decrease in comfort after numerous launderings. The combination of high heat and bending damage the yarns and other materials which create weak points within the outer layer which eventually lead to pilling, wrinkling and discomfort for the wearer after multiple launderings.

One way to improve garment wearing comfort is to treat the bra cup in order to impart a resistance to wrinkling even after numerous launderings. The present invention discloses a finish for the outer bra liner layers of the cup which reduces the wrinkling in the final molded garment. Knit goods are processed in stenter frames which allow for a front end pad bath saturation followed by a high temperature drying and/or curing step. Stenter frame (or tenter frame), as used herein, refers to a machine that dries fabric to a specified width under tension. The machine consists essentially of a pair of endless chains on horizontal tracks. The fabric is held firmly at the edges by pins or clips on the two chains that diverge as they advance through the heated chamber, adjusting the fabric to the desired width.

To counter product integrity, harsh molding conditions are minimized as best possible, but in many cases, performance and fashion requirements surmount functional properties and damaged fibers are the result of molding. Competitive alternatives to finishing have been attempted in the past, only to fail during the molding stage. The most common defect of finishes other than those of the present invention are post molded yellowing and a harsh hand. Low add on levels of the VAE polymer disclosed in the present invention and the properties of those polymers have countered the previous failures to the satisfaction of the intimate apparel industry leaders.

One embodiment of the instant invention describes a process for depositing an anti-wrinkle finish on an intimate garment comprising the steps of: a. loading a textile into a stenter frame; b. padding an aqueous finishing liquor comprising from 0.05 wt. % solids to 65 wt. % solids of a finishing resin selected from the group comprising: vinyl acetate emulsion resins, including copolymers such as vinyl acetate ethylene emulsions, vinyl acetate acrylics, acrylic emulsions, polyvinyl alcohol resins, including polyvinyl alcohol vinyl formamide copolymers, polyvinyl alcohol vinyl amine copolymers, sulfonic acid functionalized polyvinyl alcohol resins, modified polyvinyl alcohol resins generally; and mixtures thereof, onto the textile to incorporate the liquor into the textile and provide a wetted textile; c. passing the wetted textile through a nip roller at a speed and a pressure to inter-associate the finishing resin with the fibers of the textile and remove excess finishing liquor out of the wetted textile, wherein the finishing resin is durably and uniformly inter-associated with the textile fiber surfaces at an add-on level of from 0.05 wt. % to less than 65 wt. %; d. drying the wetted textile at a temperature for a length of time to provide a finished textile; e. cutting the finished textile to create an inner lining and an outer lining of an intimate garment; f. covering an inner layer having an inner side and an outer side wherein the inner lining covers the inner side and the outer lining covers the outer side of the inner layer; g. molding the inner lining and the outer lining to the inner layer at a temperature for a length of time to provide an intimate garment.

In one embodiment of the above process, the wetted textile passes through the nip roller at a speed in the range of 15 to 25 meters/minute, more preferably 17-22 meters/minute, and even more preferably, 20 meters per minute and a pressure in the range of 0.8 to 1.2 bar, more preferably 0.9 to 1.1 bar, and even more preferably 1.0 bar. In another embodiment of the above process, the wetted textile is dried for a length of time ranging from 10 to 60 seconds, more preferably 25 to 45 seconds, and even more preferably 30 to 35 seconds, at a temperature in the range of 125 to 200° C., more preferably 150 to 195° C., and even more preferably 190° C. In still another embodiment of the above process, the molding takes place for a length of time ranging from 60 to 180 seconds, more preferably 90 to 140 seconds, and even more preferably for 120 seconds at a temperature in the range of 140 to 200° C., more preferably from 150 to 180° C., and even more preferably at 160° C.

The above process may also contain a finishing resin which is a vinyl acetate emulsion resin which is a 0.5% solid solution. The finishing resin is durably and uniformly inter-associated with the textile fiber surfaces at an add-on level of from 35 wt. % to less than 40 wt. %. In one embodiment of the above process, the textile is a knit fabric comprising a synthetic fiber which may be a polyester fiber. When processing white fabric, an auxiliary chemical may be added to reduce yellowing from drying (anti-oxidant). Black fabric may include a chemical fixing agent in the pad bath with the vinyl acetate emulsion resin for improved colorfastness.

The finishing liquor in the above process may also include wetting agents, anti-foam agents, softening agents, compatibilizers, starches, chelating agents, fixing agents, buffers, coating agents, binders, latexes, release finishes, enzymes, flame retardants, optical brightners, durable press agents, anti-microbial agents, uv-stabilizers and combinations thereof.

The instant invention may also apply to the shine/luster in molded apparel products, such as the molded cups in bras. When the knit bra liner fabric is molded into cup/garment shape, the opening of the knit structure results in lost shine and luster post molding. It is estimated that 50% of the initial shine of a bra liner is lost during molding. Helping to maintain the shine that is already present in a knit fabric is key, but being able to add to the original level of shine is also highly desired. In one embodiment of the above process, the VAE resin treatment resulted in an increase to the overall shine of a polyester/spandex knit post molding by 400%. This was accomplished by a padding process of a 5% solid VAE (TruModa 731—available from Celanese Emulsion Polymers—Dallas, Tex.) (same as above) followed by a drying/curing stage in a stenter frame at 165 F for 30 to 40 seconds. The VAE works to maintain dimensional stability of the original knit structure. This stability is measured with % Recovery of Compression values, the increase in % RC leads to a molded bra liner that minimizes the volume of gaps between the knit structure yarn.

### EXAMPLES 1-10

A series of woven polyester/cotton fabrics were prepared and tested. In the description which follows, specimens are identified as G1, G2, P1, P2, Y1, Y2, T1, T2, O1, and O2. Sample identifications correspond to the colors of the fabric (grey, pink, yellow, tan, orange) and designate the control sample (#1s) from the invention samples (#2s). One specimen of material O was tested in differing locations.

The O1 control sample was an unfinished mill product, while the other control samples were finished with a commercial textile finishing composition. The invention specimens were prepared as follows:
Untreated fabric samples were treated in a continuous application process with an aqueous emulsion diluted to low concentration at a web speed of 3 meters/minute at 1 bar pressure.
The emulsion employed was a vinyl acetate/ethylene emulsion resin, polyvinyl alcohol stabilized (54% solids) and was added to the liquor at 10 g/l such that solids concentration in the bath was an emulsion solids content of about 0.5%. The emulsion used has a typical viscosity of 2300 cps, a pH of 4.5, a density of about 9 lb/gal and a Tg of 0° C.
The tested samples were cured @ 180° C. for 30 seconds, then tumble dried.

All fabrics were conditioned and tests were performed in the standard atmosphere laboratory condition of 70±3° F. (21° C.), 65±5% RH.

The Kawabata Evaluation System (KES) is used to make objective measurements of hand properties. With low forces applied, the KES instruments measure mechanical properties that correspond to the fundamental deformation of fabrics in hand manipulation. The five different classes of tests performed using KES and the main mechanical characteristics are described below.

Samples were conditioned and measurements were made using the standard specimen size of 20×20 cm (10×10 cm for bending) in three replications. All measurements are directional, except for compression, and are made in both the lengthwise direction, and in the cross direction of the sample. Appropriate instrument settings are used for the material being tested.

Weight is measured according to ASTM D 3776 small swatch option. Three specimens (20×20 cm) were weighed on an analytical balance and the weight was calculated in mass per unit area (oz/yd²).

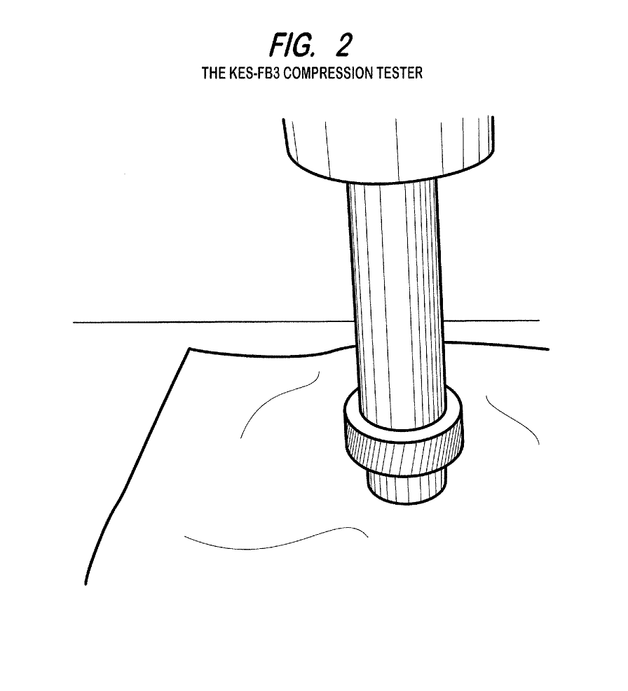

Compressional properties of a 2 cm² area, were measured with the KES-FB3 Compression Tester (FIG. 2) at 0 to 50 gf/cm² all materials.

EMC=compressibility, percent−Initial thickness measurements compared to the thickness of the sample at maximum applied force. A higher value indicates greater compressibility.

RC=compressional resilience, percent−The extent of recovery, or the regain in thickness, when the force is removed. Higher RC values indicates a higher percent recovery from being compressed.

Thickness=a 2 cm² area measured at 0.5 gf/cm² and reported in millimeters.

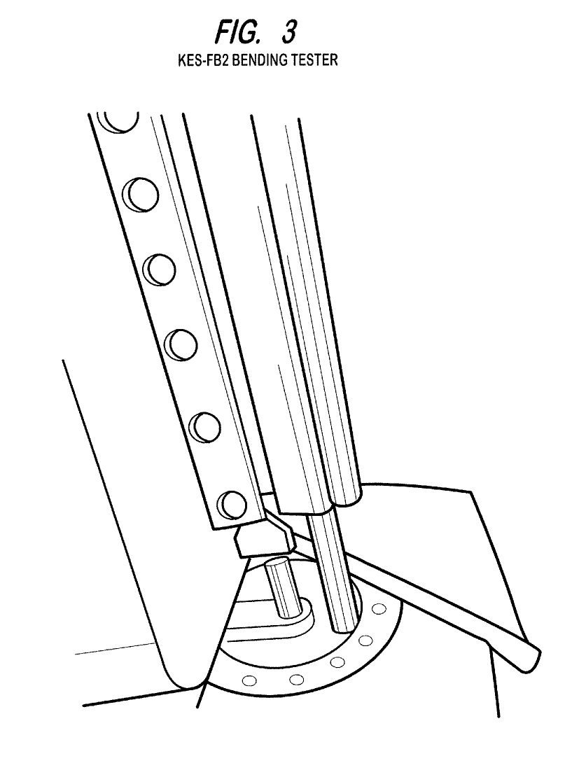

Bending, measured with KES-FB2 Bending Tester (FIG. 3), is a measure of the force required to bend the fabric approximately 150°.

B=bending rigidity per unit fabric width, gf-cm²/cm−Higher B value indicates greater stiffness/resistance to bending motions.

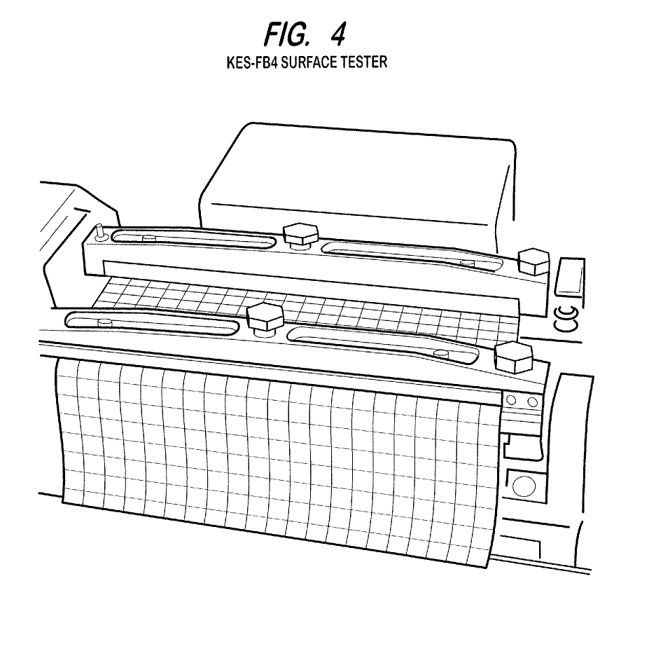

The surface properties of friction (resistance/drag) and surface contour (roughness) were determined using the KES-FB4 Surface Tester (FIG. 4). A tension load of 20 gf/cm is applied to the sample in the standard test.

MIU=coefficient of friction, 0 to 1 value−Higher MIU value corresponds to greater friction or resistance and drag.

SMD=geometric roughness, micron−Higher SMD corresponds to geometrically rougher surface.

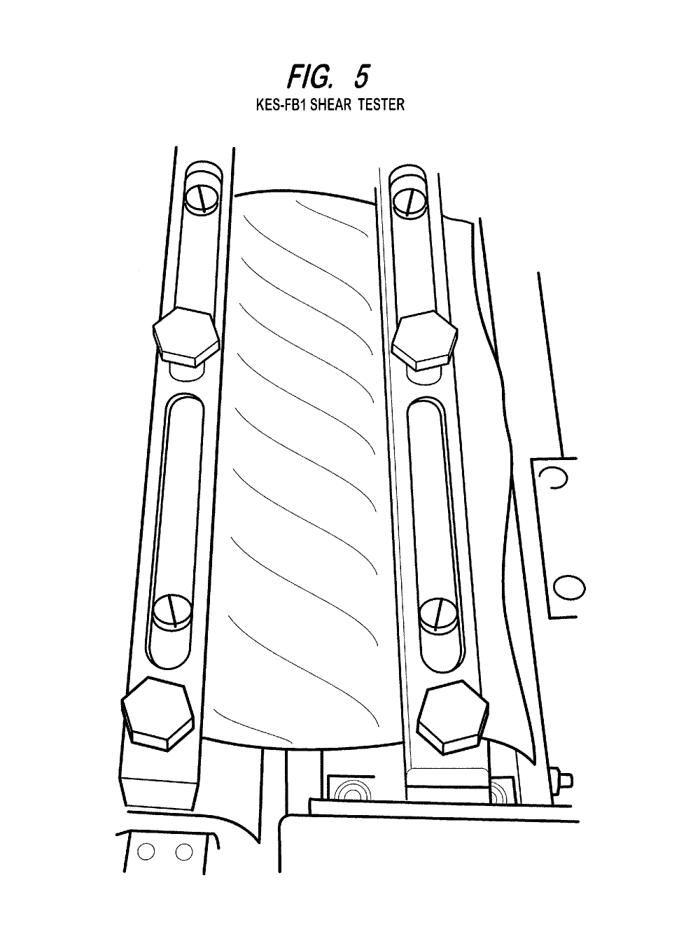

Shearing=In shear testing, the KES-FB1 Tensile-Shear Tester (FIG. 5) applies opposing, parallel forces to the fabric, until a maximum offset angle of 8° is reached. A pretension load of 10 gf/cm is applied to the specimen.

G=shear stiffness, gf/cm·degree−Shearing stiffness is the ease with which the fibers slide against each other resulting in soft/pliable to stiff/rigid structures. Lower values indicate less resistance to the shearing movement corresponding to a softer material having better drape.

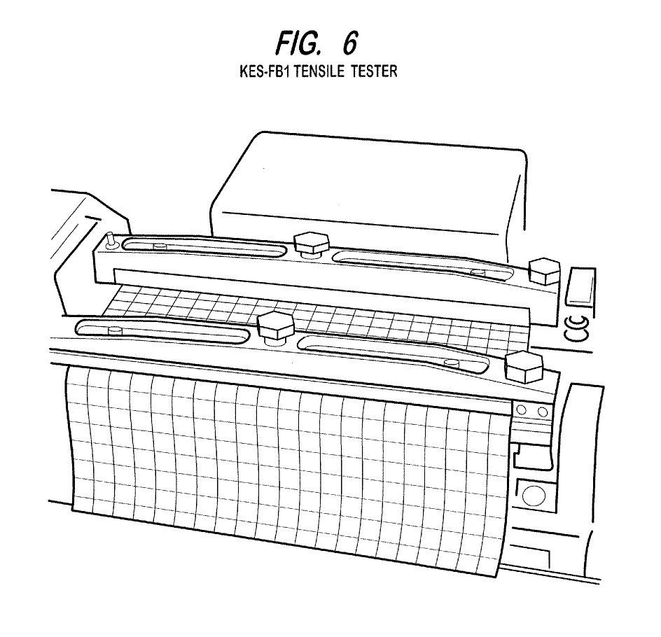

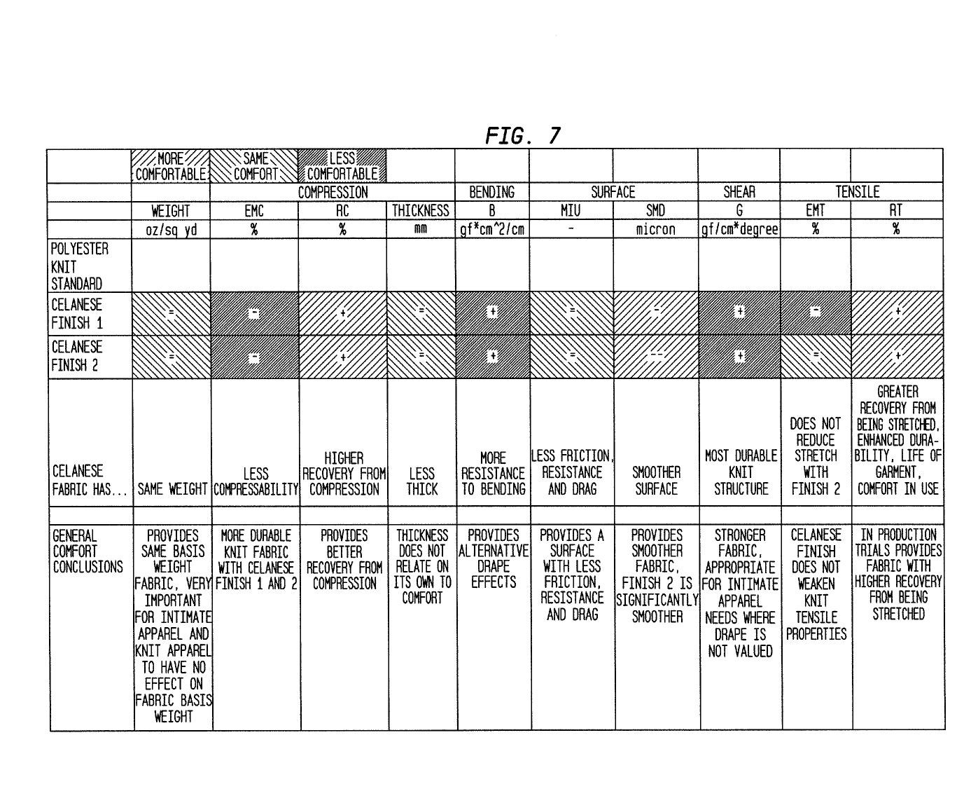

Tensile=The tensile test, done on the KES-FB1 (FIG. 6) Tensile-Shear tester, measures the stress/strain parameters at the maximum load of 250 gf/cm used for these materials.

EMT=extensibility or stretch, percent strain at maximum applied force. 100%=completely elastic; 0%=completely inelastic. Higher values indicate a stretchier material.

RT=tensile resilience, percent−Indicates the recovery of deformation from strain, or the inability to recover from stretching, when the applied force is removed. Higher values indicate greater recovery from having been stretched.

Table 1 contains a summary of the test results with detailed data appearing in Tables 2-7.

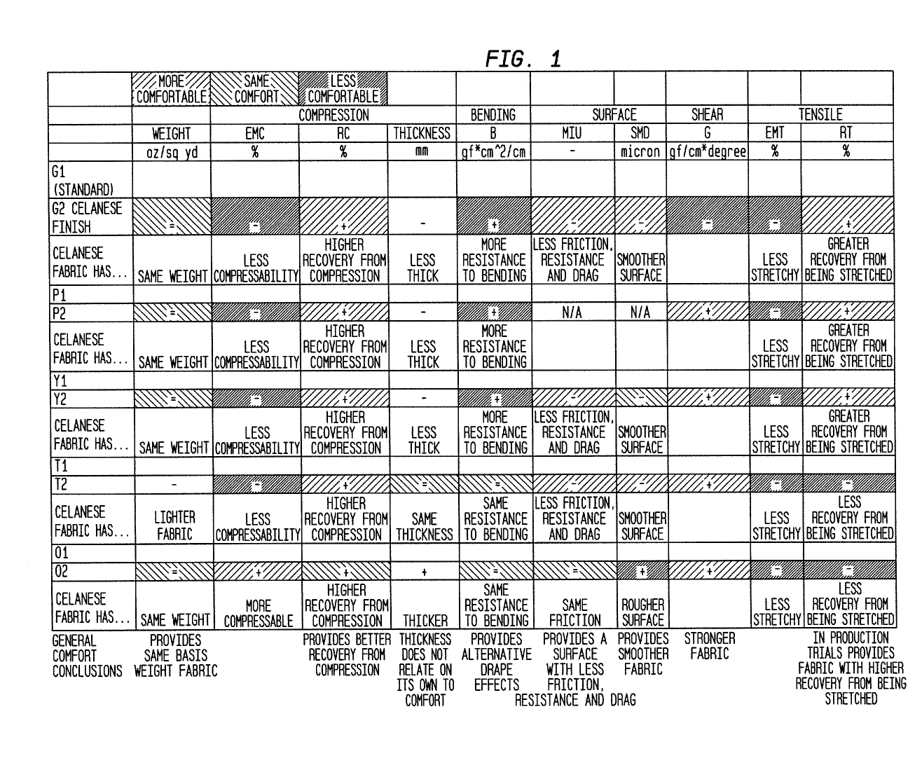

Results are also summarized in FIG. 1, which is a chart illustrating various comfort-related features of the fabrics.

TABLE 1
Summary of Mechanical Hand Properties

| | Sample Identification | | | | | | | | | |
|---|---|---|---|---|---|---|---|---|---|---|
| Property | G1 | G2 | P1 | P2 | Y1 | Y2 | T1 | T2 | O1 | O2 |
| Weight (oz/yd²) | 3.77 | 3.75 | 4.24 | 4.17 | 4.02 | 3.97 | 3.26 | 3.01 | 3.99 | 3.96 |
| Compression: | | | | | | | | | | |
| EMC (%)^{a} | 49.64 | 37.29 | 44.19 | 41.77 | 38.42 | 27.51 | 58.31 | 47.77 | 42.59 | 51.27 |
| RC (%)^{b} | 31.11 | 32.86 | 29.78 | 31.63 | 30.58 | 34.92 | 30.42 | 31.92 | 27.99 | 30.47 |
| Thickness (mm) | 0.52 | 0.39 | 0.82 | 0.62 | 0.74 | 0.49 | 0.49 | 0.32 | 0.41 | 0.53 |
| Bending: | | | | | | | | | | |
| B (gf * cm²/cm)^{c} | 0.03 | 0.04 | 0.05 | 0.07 | 0.05 | 0.06 | 0.04 | 0.04 | 0.05 | 0.05 |
| Surface: | | | | | | | | | | |
| MIU (—)^{d} | 0.26 | 0.25 | * | * | 0.29 | 0.28 | 0.25 | 0.24 | 0.26 | 0.27 |
| SMD (micron)^{e} | 3.84 | 3.42 | * | * | 8.48 | 7.81 | 2.53 | 2.20 | 3.72 | 4.07 |
| Shear: | | | | | | | | | | |
| G (gf/cm * degree)^{f} | 0.45 | 0.43 | 0.60 | 0.89 | 0.35 | 0.43 | 0.74 | 0.85 | 1.02 | 1.04 |
| Tensile: | | | | | | | | | | |
| EMT (%)^{g} | 5.37 | 4.09 | 5.16 | 4.08 | 4.89 | 3.65 | 5.76 | 4.77 | 4.00 | 3.52 |
| RT (%)^{h} | 45.61 | 52.53 | 44.39 | 44.67 | 47.89 | 49.36 | 44.18 | 37.72 | 48.17 | 47.82 |

^{a}A high EMC value indicates greater compressability.
^{b}High values mean a higher percent recovery from being compressed.
^{c}Low B values indicate less stiffness or resistance to bending motions.
^{d}Lower MIU corresponds to less friction or resistance and drag.
^{e}Low SMD values indicate a smoother surface.
^{f}A low value indicates less resistance to shearing movements; soft, pliable, drapeable.
^{g}High EMT indicates a stretchier material.
^{h}A high value indicates greater recovery from having been stretched.
* The seersucker fabric construction created difficulties in obtaining consistent results.

TABLE 2
Weight*

Replicates (grams)

| Sample ID | 1 | 2 | 3 | Average | (oz/yd²) |
|---|---|---|---|---|---|
| G1 | 5.08 | 5.11 | 5.13 | 5.11 | 3.77 |
| G2 | 5.11 | 5.09 | 5.05 | 5.08 | 3.75 |
| P1 | 5.68 | 5.77 | 5.81 | 5.75 | 4.24 |
| P2 | 5.65 | 5.72 | 5.61 | 5.66 | 4.17 |
| Y1 | 5.40 | 5.44 | 5.52 | 5.45 | 4.02 |
| Y2 | 5.39 | 5.44 | 5.33 | 5.39 | 3.97 |
| T1 | 4.41 | 4.37 | 4.48 | 4.42 | 3.26 |
| T2 | 4.09 | 4.11 | 4.04 | 4.08 | 3.01 |
| O1 | 5.41 | ** | ** | ** | 3.99 |
| O2 | 5.37 | ** | ** | ** | 3.96 |

*20 × 20 cm sample.
** Only one specimen available.

TABLE 3
KES Compression Data

| | WC | RC^{a} | LC | | |
|---|---|---|---|---|---|
| | Compressional | Compressional | Linearity of | EMC | |
| Sample ID - | Energy | Resilience | Compression | Compressibility | Thickness* |
| replicate | (gf · cm/cm²) | (%) | (—) | (%) | (mm) |
| G1 | | | | | |
| -1 | 0.22 | 33.62 | 0.35 | 49.62 | 0.52 |
| -2 | 0.21 | 29.86 | 0.35 | 48.46 | 0.50 |
| -3 | 0.24 | 29.85 | 0.35 | 50.84 | 0.54 |
| Avg. | 0.22 | 31.11 | 0.35 | 49.64 | 0.52 |
| G2 | | | | | |
| -1 | 0.16 | 31.30 | 0.37 | 40.71 | 0.42 |
| -2 | 0.14 | 31.22 | 0.41 | 34.75 | 0.39 |
| -3 | 0.12 | 36.05 | 0.36 | 36.42 | 0.36 |
| Avg. | 0.14 | 32.86 | 0.38 | 37.29 | 0.39 |
| P1 | | | | | |
| -1 | 0.42 | 28.96 | 0.50 | 43.06 | 0.78 |
| -2 | 0.48 | 31.47 | 0.56 | 41.96 | 0.81 |
| -3 | 0.47 | 28.90 | 0.45 | 47.54 | 0.88 |
| Avg. | 0.45 | 29.78 | 0.50 | 44.19 | 0.82 |
| P2 | | | | | |
| -1 | 0.36 | 33.39 | 0.55 | 42.12 | 0.63 |
| -2 | 0.37 | 31.01 | 0.60 | 40.98 | 0.61 |
| -3 | 0.37 | 30.49 | 0.57 | 42.22 | 0.62 |
| Avg. | 0.37 | 31.63 | 0.57 | 41.77 | 0.62 |
| Y1 | | | | | |
| -1 | 0.43 | 30.39 | 0.58 | 40.33 | 0.73 |
| -2 | 0.42 | 30.13 | 0.66 | 36.45 | 0.70 |
| -3 | 0.47 | 31.21 | 0.63 | 38.47 | 0.78 |
| Avg. | 0.44 | 30.58 | 0.62 | 38.42 | 0.74 |
| Y2 | | | | | |
| -1 | 0.22 | 35.54 | 0.56 | 30.36 | 0.51 |
| -2 | 0.20 | 36.22 | 0.66 | 24.90 | 0.49 |
| -3 | 0.18 | 32.99 | 0.57 | 27.28 | 0.47 |
| Avg. | 0.20 | 34.92 | 0.60 | 27.51 | 0.49 |
| T1 | | | | | |
| -1 | 0.16 | 31.65 | 0.34 | 49.19 | 0.38 |
| -2 | 0.22 | 30.19 | 0.28 | 61.30 | 0.51 |
| -3 | 0.22 | 29.43 | 0.24 | 64.45 | 0.58 |
| Avg. | 0.20 | 30.42 | 0.29 | 58.31 | 0.49 |
| T2 | | | | | |
| -1 | 0.18 | 27.66 | 0.39 | 52.02 | 0.35 |
| -2 | 0.14 | 35.01 | 0.34 | 50.29 | 0.33 |
| -3 | 0.11 | 33.07 | 0.42 | 41.00 | 0.26 |
| Avg. | 0.15 | 31.92 | 0.38 | 47.77 | 0.32 |
| O1 | | | | | |
| -1 | 0.21 | 27.38 | 0.56 | 38.07 | 0.40 |
| -2 | 0.18 | 28.69 | 0.40 | 45.12 | 0.40 |
| -3 | 0.19 | 27.89 | 0.41 | 44.58 | 0.41 |
| Avg. | 0.19 | 27.99 | 0.45 | 42.59 | 0.41 |
| O2 | | | | | |
| -1 | 0.25 | 31.39 | 0.19 | 68.65 | 0.76 |
| -2 | 0.22 | 29.86 | 0.49 | 42.97 | 0.42 |
| -3 | 0.19 | 30.15 | 0.45 | 42.20 | 0.41 |
| Avg. | 0.22 | 30.47 | 0.37 | 51.27 | 0.53 |

*Thickness of a 2 cm² area at 0.5 gf/cm².
^{a}Higher values mean higher percent recovery from being compressed.
^{b}Higher values indicate greater compressibility.

TABLE 4
KES Bending Data*

| | |
|---|---|
| | 2HB^{b} |
| B^{a} | Hysteresis of |
| Bending Rigidity | Bending Momentum |
| (gf · cm²/cm) | (gf · cm/cm) |

| Sample ID | (L) | (C) | (L) | (C) |
|---|---|---|---|---|
| G1 | | | | |
| -1 | 0.02 | 0.03 | 0.01 | 0.02 |
| -2 | 0.02 | 0.03 | 0.01 | 0.02 |
| -3 | 0.02 | 0.03 | 0.01 | 0.02 |
| Avg. | 0.02 | 0.03 | 0.01 | 0.02 |

| | | |
|---|---|---|
| L + C | 0.03 | 0.02 |

| | | | | |
|---|---|---|---|---|
| G2 | | | | |
| -1 | 0.03 | 0.05 | 0.02 | 0.05 |
| -2 | 0.03 | 0.06 | 0.02 | 0.06 |
| -3 | 0.04 | 0.04 | 0.03 | 0.03 |
| -4 | 0.03 | 0.05 | 0.02 | 0.04 |
| Avg. | 0.03 | 0.05 | 0.02 | 0.05 |

| | | |
|---|---|---|
| L + C | 0.04 | 0.03 |

| | | | | |
|---|---|---|---|---|
| P1 | | | | |
| -1 | 0.06 | 0.05 | 0.07 | 0.06 |
| -2 | 0.05 | 0.06 | 0.08 | 0.07 |
| -3 | 0.04 | 0.06 | 0.09 | 0.10 |
| Avg. | 0.05 | 0.06 | 0.08 | 0.08 |

| | | |
|---|---|---|
| L + C | 0.05 | 0.08 |

| | | | | |
|---|---|---|---|---|
| P2 | | | | |
| -1 | 0.05 | 0.06 | 0.07 | 006 |
| -2 | 0.08 | 0.08 | 0.11 | 0.07 |
| -3 | 0.08 | 0.06 | 0.11 | 0.05 |
| -4 | 0.05 | 0.07 | 0.09 | 0.07 |
| Avg. | 0.07 | 0.07 | 0.09 | 0.06 |

| | | |
|---|---|---|
| L + C | 0.07 | 0.08 |

| | | | | |
|---|---|---|---|---|
| Y1 | | | | |
| -1 | 0.02 | 0.08 | 0.02 | 0.09 |
| -2 | 0.02 | 0.08 | 0.02 | 0.09 |
| -3 | 0.03 | 0.08 | 0.02 | 0.08 |
| -4 | | 0.08 | | 0.08 |
| Avg. | 0.03 | 0.08 | 0.02 | 0.09 |

| | | |
|---|---|---|
| L + C | 0.05 | 0.05 |

| | | | | |
|---|---|---|---|---|
| Y2 | | | | |
| -1 | 0.04 | 0.07 | 0.03 | 0.07 |
| -2 | 0.04 | 0.11 | 0.03 | 0.11 |
| -3 | 0.04 | 0.09 | 0.03 | 0.11 |
| Avg. | 0.04 | 0.09 | 0.03 | 0.10 |

| | | |
|---|---|---|
| L + C | 0.06 | 0.06 |

| | | | | |
|---|---|---|---|---|
| T1 | | | | |
| -1 | 0.03 | 0.04 | 0.05 | 0.05 |
| -2 | 0.03 | 0.05 | 0.03 | 0.06 |
| -3 | 0.02 | 0.04 | 0.03 | 0.05 |
| -4 | 0.03 | | 0.03 | |
| Avg. | 0.03 | 0.05 | 0.03 | 0.06 |

| | | |
|---|---|---|
| L + C | 0.04 | 0.04 |

| | | | | |
|---|---|---|---|---|
| T2 | | | | |
| -1 | 0.04 | 0.04 | 0.03 | 0.04 |
| -2 | 0.04 | 0.04 | 0.04 | 0.04 |
| -3 | 0.04 | 0.04 | 0.03 | 0.04 |
| -4 | 0.03 | | 0.03 | |
| Avg. | 0.04 | 0.04 | 0.04 | 0.04 |

| | | |
|---|---|---|
| L + C | 0.04 | 0.04 |

| | | | | |
|---|---|---|---|---|
| O1 | | | | |
| -1 | 0.06 | 0.04 | 0.06 | 0.06 |
| -2 | 0.06 | 0.04 | 0.07 | 0.07 |
| -3 | 0.06 | 0.04 | 0.07 | 0.06 |
| Avg. | 0.06 | 0.04 | 0.07 | 0.06 |

| | | |
|---|---|---|
| L + C | 0.05 | 0.06 |

| | | | | |
|---|---|---|---|---|
| O2 | | | | |
| -1 | 0.06 | 0.04 | 0.07 | 0.07 |
| -2 | 0.06 | 0.04 | 0.07 | 0.07 |
| -3 | 0.07 | 0.04 | 0.09 | 0.07 |
| Avg. | 0.06 | 0.04 | 0.08 | 0.07 |

| | | |
|---|---|---|
| L + C | 0.05 | 0.08 |

Note:
L = lengthwise direction;
C = crosswise direction
^{a}Higher B value indicates greater stiffness/resistance to bending motions.
^{b}A larger 2HB value means greater fabric inelasticity.

TABLE 5
KES Surface Data

| | MIU^{a} | | MMD^{b} | | SMD^{c} | |
|---|---|---|---|---|---|---|
| | Coefficient | | Mean Deviation | | Geometric | |
| | of Friction | | of MIU | | Roughness | |
| Sample ID - | (—) | | (—) | | (micron) | |
| Replicate | (L) | (C) | (L) | (C) | (L) | (C) |
| G1 | | | | | | |
| -1 | 0.30 | 0.27 | 0.03 | 0.03 | 4.45 | 4.95 |
| -2 | 0.26 | 0.26 | 0.02 | 0.02 | 3.99 | 3.42 |
| -3 | 0.26 | 0.25 | 0.02 | 0.02 | 3.32 | 2.91 |
| Avg. | 0.27 | 0.26 | 0.02 | 0.02 | 3.92 | 3.76 |
| L + C | 0.26 | | 0.02 | | 3.84 | |
| G2 | | | | | | |
| -1 | 0.24 | 0.28 | 0.02 | 0.04 | 3.88 | 2.64 |
| -2 | 0.29 | 0.23 | 0.03 | 0.02 | 3.44 | 4.84 |
| -3 | 0.25 | 0.22 | 0.02 | 0.02 | 3.34 | 2.36 |
| Avg. | 0.26 | 0.24 | 0.02 | 0.03 | 3.55 | 3.28 |
| L + C | 0.25 | | 0.02 | | 3.42 | |
| P1* | | | | | | |
| -1 | | | | | | |
| -2 | | | | | | |
| -3 | | | | | | |
| Avg. | | | | | | |
| L + C | | | | | | |
| P2* | | | | | | |
| -1 | | | | | | |
| -2 | | | | | | |
| -3 | | | | | | |
| -4 | | | | | | |
| Avg. | | | | | | |
| L + C | | | | | | |
| Y1 | | | | | | |
| -1 | 0.28 | 0.29 | 0.04 | 0.07 | 7.77 | 8.78 |
| -2 | 0.31 | 0.27 | 0.05 | 0.05 | 8.17 | 9.55 |
| -3 | 0.31 | 0.29 | 0.06 | 0.06 | 6.36 | 10.24 |
| Avg. | 0.30 | 0.28 | 0.05 | 0.06 | 7.43 | 9.52 |
| L + C | 0.29 | | 0.06 | | 8.48 | |
| Y2 | | | | | | |
| -1 | 0.28 | 0.26 | 0.05 | 0.05 | 8.39 | 6.93 |
| -2 | 0.27 | 0.26 | 0.05 | 0.06 | 8.60 | 7.88 |
| -3 | 0.30 | 0.28 | 0.06 | 0.06 | 6.46 | 8.62 |
| Avg. | 0.28 | 0.27 | 0.05 | 0.05 | 7.82 | 7.81 |
| L + C | 0.28 | | 0.05 | | 7.81 | |
| T1 | | | | | | |
| -1 | 0.25 | 0.24 | 0.01 | 0.02 | 1.63 | 2.99 |
| -2 | 0.28 | 0.23 | 0.02 | 0.02 | 3.05 | 3.26 |
| -3 | 0.27 | 0.24 | 0.02 | 0.02 | 1.43 | 2.82 |
| Avg. | 0.27 | 0.24 | 0.02 | 0.02 | 2.04 | 3.02 |
| L + C | 0.25 | | 0.02 | | 2.53 | |
| T2 | | | | | | |
| -1 | 0.25 | 0.23 | 0.01 | 0.02 | 1.90 | 2.37 |
| -2 | 0.24 | 0.22 | 0.01 | 0.02 | 3.09 | 2.16 |
| -3 | 0.24 | 0.23 | 0.01 | 0.02 | 1.56 | 2.15 |
| Avg. | 0.24 | 0.23 | 0.01 | 0.02 | 2.18 | 2.23 |
| L + C | 0.24 | | 0.02 | | 2.20 | |
| O1 | | | | | | |
| -1 | 0.26 | 0.26 | 0.02 | 0.02 | 3.16 | 4.68 |
| -2 | 0.25 | 0.27 | 0.02 | 0.02 | 2.86 | 4.53 |
| -3 | 0.24 | 0.26 | 0.01 | 0.02 | 3.04 | 4.05 |
| Avg. | 0.25 | 0.26 | 0.02 | 0.02 | 3.02 | 4.42 |
| L + C | 0.26 | | 0.02 | | 3.72 | |
| O2 | | | | | | |
| -1 | 0.29 | 0.26 | 0.02 | 0.02 | 3.29 | 5.14 |
| -2 | 0.28 | 0.25 | 0.02 | 0.02 | 2.45 | 4.71 |
| -3 | 0.29 | 0.25 | 0.02 | 0.02 | 3.22 | 5.62 |
| Avg. | 0.28 | 0.26 | 0.02 | 0.02 | 2.99 | 5.16 |

| | | | |
|---|---|---|---|
| L + C | 0.27 | 0.02 | 4.07 |

Note:
L = lengthwise direction;
C = crosswise direction
^{a}Values from 0 to 1 with higher values corresponding to higher friction, indicating a smoother surface.
^{b}Higher value corresponds to larger variations of friction.
^{c}Higher values mean a geometrically rougher surface.
*The seersucker fabric construction created difficulties in obtaining consistent results.

TABLE 6
Detailed KES Shear Test Data

| | | | 2HG | | | |
|---|---|---|---|---|---|---|
| | | | Hysteresis of | | 2HG5 | |
| | | | Shear Force | | Hysteresis of | |
| | | | @ 0.5 Degrees | | Shear Force | |
| | G^{a} | | of Shear | | @ 5.0 Degrees | |
| | Shear Stiffness | | Angle | | of Shear Angle | |
| Sample ID - | (gf/cm · Degree) | | (gf/cm) | | (gf/cm) | |
| Replicate | (L) | (C) | (L) | (C) | (L) | (C) |
| G1 | | | | | | |
| -1 | 0.43 | 0.40 | 0.64 | 0.27 | 1.51 | 1.21 |
| -2 | 0.60 | 0.40 | 0.74 | 0.29 | 2.34 | 1.40 |
| -3 | 0.54 | 0.32 | 0.74 | 0.30 | 2.29 | 1.10 |
| Avg. | 0.52 | 0.37 | 0.71 | 0.29 | 2.05 | 1.24 |
| L + C | 0.45 | | 0.50 | | 1.64 | |
| G2 | | | | | | |
| -1 | 0.49 | 0.35 | 0.60 | 0.45 | 1.75 | 0.83 |
| -2 | 0.43 | 0.35 | 0.57 | 0.28 | 1.81 | 1.41 |
| -3 | 0.69 | 0.31 | 0.66 | 0.18 | 2.94 | 1.05 |
| -4 | | 0.30 | | 0.47 | | 0.84 |
| Avg. | 0.53 | 0.33 | 0.61 | 0.34 | 2.17 | 1.03 |
| L + C | 0.43 | | 0.48 | | 1.60 | |
| P1 | | | | | | |
| -1 | 0.61 | 0.57 | 1.46 | 1.22 | 2.43 | 2.26 |
| -2 | 0.64 | 0.60 | 1.67 | 1.37 | 2.74 | 2.52 |
| -3 | 0.57 | 0.57 | 1.43 | 1.26 | 2.24 | 2.32 |
| Avg. | 0.61 | 0.58 | 1.52 | 1.28 | 2.47 | 2.37 |
| L + C | 0.60 | | 1.40 | | 2.42 | |
| P2 | | | | | | |
| -1 | 0.95 | 0.81 | 2.58 | 1.83 | 4.17 | 3.37 |
| -2 | 1.00 | 0.86 | 2.67 | 2.10 | 4.39 | 3.93 |
| -3 | 0.82 | 0.88 | 2.21 | 2.21 | 3.62 | 3.97 |
| Avg. | 0.92 | 0.85 | 2.48 | 2.05 | 4.06 | 3.75 |
| L + C | 0.89 | | 2.27 | | 3.91 | |
| Y1 | | | | | | |
| -1 | 0.39 | 0.30 | 0.91 | 0.35 | 1.37 | 0.76 |
| -2 | 0.40 | 0.30 | 0.94 | 0.30 | 1.43 | 0.79 |
| -3 | 0.37 | 0.33 | 0.95 | 0.29 | 1.38 | 0.84 |
| Avg. | 0.39 | 0.31 | 0.93 | 0.31 | 1.40 | 0.80 |
| L + C | 0.35 | | 0.62 | | 1.10 | |
| Y2 | | | | | | |
| -1 | 0.51 | 0.36 | 0.91 | 0.36 | 1.85 | 1.11 |
| -2 | 0.48 | 0.38 | 0.99 | 0.29 | 1.72 | 1.06 |
| -3 | 0.44 | 0.39 | 0.86 | 0.35 | 1.53 | 1.16 |
| Avg. | 0.48 | 0.38 | 0.92 | 0.34 | 1.70 | 1.11 |
| L + C | 0.43 | | 0.63 | | 1.40 | |
| T1 | | | | | | |
| -1 | 0.83 | 0.70 | 2.19 | 1.09 | 3.67 | 2.82 |
| -2 | 0.80 | 0.69 | 2.37 | 1.17 | 3.62 | 2.78 |
| -3 | 0.74 | 0.69 | 2.15 | 1.20 | 3.32 | 2.76 |
| Avg. | 0.79 | 0.69 | 2.24 | 1.15 | 3.54 | 2.79 |
| L + C | 0.74 | | 1.69 | | 3.16 | |
| T2 | | | | | | |
| -1 | 0.86 | 0.76 | 3.02 | 1.74 | 4.30 | 3.36 |
| -2 | 0.94 | 0.87 | 3.36 | 1.94 | 4.67 | 3.75 |
| -3 | 0.87 | 0.83 | 3.23 | 1.89 | 4.51 | 3.63 |
| Avg. | 0.89 | 0.82 | 3.20 | 1.85 | 4.49 | 3.58 |
| L + C | 0.85 | | 2.53 | | 4.04 | |
| O1 | | | | | | |
| -1 | 1.08 | 0.99 | 4.67 | 3.48 | 5.98 | 5.12 |
| -2 | 1.08 | 0.99 | 4.61 | 3.74 | 5.97 | 5.32 |
| -3 | 1.01 | 0.98 | 4.29 | 3.67 | 5.71 | 5.11 |
| Avg. | 1.05 | 0.99 | 4.53 | 3.63 | 5.89 | 5.18 |
| L + C | 1.02 | | 4.08 | | 5.53 | |
| O2 | | | | | | |
| -1 | 1.09 | 1.01 | 4.89 | 3.76 | 6.16 | 5.53 |
| -2 | 1.08 | 1.03 | 4.66 | 3.78 | 5.96 | 5.55 |
| -3 | 1.01 | 0.99 | 4.64 | 3.58 | 5.92 | 5.30 |
| Avg. | 1.06 | 1.01 | 4.73 | 3.71 | 6.01 | 5.46 |

| | | | |
|---|---|---|---|
| L + C | 1.04 | 4.22 | 5.74 |

Note:
L = lengthwise direction;
C = crosswise direction
^{a}Higher value means greater stiffness/resistance to shearing movement.

TABLE 7
Detailed KES Tensile Data

| | WT | | | | LT | | | |
|---|---|---|---|---|---|---|---|---|
| | Tensile | | RT^{a} | | Linearity of | | | |
| | Energy | | Tensile | | Load- | | EMT^{b} | |
| Sample | (gf · | | Resilience | | Extension | | Extensibility | |
| ID - | cm/cm²) | | (%) | | Curve | | (%) | |
| Replicate | (L) | (C) | (L) | (C) | (—) | | (L) | (C) |
| G1 | | | | | | | | |
| -1 | 7.21 | 3.07 | 49.15 | 40.10 | 0.77 | 0.89 | 7.52 | 2.78 |
| -2 | 7.53 | 2.70 | 49.22 | 43.73 | 0.75 | 0.78 | 7.99 | 2.78 |
| -3 | 7.91 | 2.84 | 49.22 | 42.21 | 0.73 | 0.92 | 8.68 | 2.48 |
| Avg. | 7.55 | 2.87 | 49.20 | 42.01 | 0.75 | 0.86 | 8.07 | 2.68 |
| L + C | 5.21 | | 45.61 | | 0.80 | | 5.37 | |
| G2 | | | | | | | | |
| -1 | 5.95 | 2.16 | 56.33 | 52.53 | 0.75 | 0.86 | 6.33 | 2.00 |
| -2 | 6.38 | 2.30 | 56.02 | 44.23 | 0.77 | 0.87 | 6.62 | 2.10 |
| -3 | 3.90 | 3.35 | 52.89 | 53.19 | 0.76 | 0.80 | 4.11 | 3.36 |
| Avg. | 5.41 | 2.60 | 55.08 | 49.98 | 0.76 | 0.85 | 5.69 | 2.49 |
| L + C | 4.01 | | 52.53 | | 0.80 | | 4.09 | |
| P1 | | | | | | | | |
| -1 | 5.44 | 4.06 | 36.34 | 51.83 | 0.89 | 0.66 | 4.88 | 4.95 |
| -2 | 6.18 | 3.67 | 36.65 | 48.22 | 0.82 | 0.77 | 6.06 | 3.80 |
| -3 | 6.66 | 3.69 | 38.48 | 54.85 | 0.75 | 0.72 | 7.11 | 4.12 |
| Avg. | 6.10 | 3.81 | 37.16 | 51.63 | 0.82 | 0.71 | 6.02 | 4.29 |

| | | | | |
|---|---|---|---|---|
| L + C | 4.95 | 44.39 | 0.77 | 5.16 |

| P2 | | | | | | | | |
|---|---|---|---|---|---|---|---|---|
| -1 | 5.01 | 3.34 | 38.30 | 48.51 | 0.85 | 0.81 | 4.73 | 3.30 |
| -2 | 4.75 | 3.20 | 40.17 | 51.16 | 0.86 | 0.71 | 4.43 | 3.60 |
| -3 | 4.86 | 3.56 | 40.11 | 49.77 | 0.85 | 0.73 | 4.57 | 3.88 |
| Avg. | 4.87 | 3.37 | 39.53 | 49.81 | 0.85 | 0.75 | 4.58 | 3.59 |
| L + C | 4.12 | | 44.67 | | 0.80 | | 4.08 | |
| Y1 | | | | | | | | |
| -1 | 7.22 | 1.39 | 50.13 | 48.04 | 0.78 | 0.82 | 7.42 | 1.35 |
| -2 | 7.37 | 1.54 | 50.92 | 44.85 | 0.72 | 0.89 | 8.15 | 1.39 |
| -3 | 8.31 | 1.63 | 50.94 | 42.44 | 0.70 | 0.86 | 9.50 | 1.52 |
| Avg. | 7.63 | 1.52 | 50.66 | 45.11 | 0.73 | 0.86 | 8.35 | 1.42 |
| L + C | 4.58 | | 47.89 | | 0.79 | | 4.89 | |
| Y2 | | | | | | | | |
| -1 | 5.13 | 1.83 | 47.43 | 49.00 | 0.80 | 0.79 | 5.12 | 1.85 |
| -2 | 6.05 | 1.80 | 49.74 | 51.36 | 0.80 | 0.70 | 6.02 | 2.05 |
| -3 | 5.36 | 1.48 | 48.95 | 51.66 | 0.78 | 0.85 | 5.52 | 1.40 |
| -4 | 1.54 | 48.06 | 0.72 | 1.72 | | | | |
| Avg. | 5.51 | 1.66 | 48.71 | 50.02 | 0.79 | 0.76 | 5.55 | 1.75 |
| L + C | 3.59 | | 49.36 | | 0.78 | | 3.65 | |
| T1 | | | | | | | | |
| -1 | 8.17 | 3.04 | 44.85 | 38.12 | 0.79 | 0.82 | 8.23 | |
| -2 | 8.48 | 1.93 | 47.00 | 45.71 | 0.78 | 0.86 | 8.71 | |
| -3 | 10.06 | 2.31 | 45.23 | 44.14 | 0.75 | 0.84 | 10.70 | |
| Avg. | 8.90 | 2.43 | 45.69 | 42.66 | 0.78 | 0.84 | 9.21 | |
| L + C | 5.66 | | 44.18 | | 0.81 | | 5.76 | |
| T2 | | | | | | | | |
| -1 | 7.70 | 2.30 | 38.69 | 42.51 | 0.85 | 0.81 | 7.23 | 2.27 |
| -2 | 12.62 | 2.47 | 23.78 | 42.18 | 1.12 | 0.75 | 9.04 | 2.65 |
| -3 | 7.48 | 2.83 | 35.49 | 34.76 | 1.02 | 0.83 | 5.88 | 2.72 |
| -4 | 6.10 | 44.50 | 0.84 | 5.81 | | | | |
| Avg. | 8.48 | 2.53 | 35.62 | 39.82 | 0.96 | 0.80 | 6.99 | 2.55 |
| L + C | 5.51 | | 37.72 | | 0.88 | | 4.77 | |
| O1* | | | | | | | | |
| -1 | 3.73 | 3.96 | 47.36 | 49.57 | 0.72 | 0.78 | 4.16 | 4.05 |
| -2 | 3.56 | 3.66 | 44.83 | 50.93 | 0.73 | 0.76 | 3.92 | 3.85 |
| -3 | | | | | | | | |
| Avg. | 3.64 | 3.81 | 46.09 | 50.25 | 0.72 | 0.77 | 4.04 | 3.95 |
| L + C | 3.72 | | 48.17 | | 0.75 | | 4.00 | |
| O2* | | | | | | | | |
| -1 | 3.35 | 3.31 | 51.12 | 49.23 | 0.83 | 0.79 | 3.23 | 3.38 |
| -2 | 4.43 | 3.10 | 41.26 | 49.67 | 0.88 | 0.72 | 4.04 | 3.42 |
| -3 | | | | | | | | |
| Avg. | 3.89 | 3.21 | 46.19 | 49.45 | 0.85 | 0.75 | 3.64 | 3.40 |

| | | | | |
|---|---|---|---|---|
| L + C | 3.55 | 47.82 | 0.80 | 3.52 |

Note:
L = lengthwise direction;
C = crosswise direction
^{a}Higher value indicates better recovery from deformation of strain.
^{b} Strain at maximum load with 100% = complete elasticity and 0% = complete inelasticity.
*Tested each end of one specimen.

FIG. 1 summarizes differences between fabrics treated in accordance with the invention and conventional finishes.

With respect to basis weight, it is seen that the fabrics finished with the standard mill finish were no heavier than the invention finish. The key point here is the standard finish is made up of 4 products while the invention finish has only 1 primary component. As the 4 products in the standard formulation have more solids than the Celanese finish, it clearly is less efficient in use as the two finishes provide a similar add-on. Thus it is seen that the finishes employed with the invention have surprising substantivity and strike rate.

As to compression, EMC % describes the ability for a fabric to compress (become thinner) at the point of contact from a finger, or multiple fingers. This is one variable that we rate “lower” in assumed comfort. There are two reasons this may not mean we are less comfortable. One, this is a woven material, and usually, EMC is more relative to knitted apparel fabric, where the fabric is expected to adjust to compression forces more than a woven matrix. Second, the invention polymer in this case creates a stronger matrix, adding to the strength of the fabric, this prevents compression (not completely, just relative to the standard), but enhances strength properties.

Where compression is limited, “Recovery” of compression is better than the standard. This adds to the overall durability of the woven fabric and the feeling of “newness”.

Thickness is generally less with the invention finish. This variable in comfort is customer specific, some would want thicker fabric (in the case of fleece or outerwear/sweaters, et al) but this type of light woven goods would not require thicker hand for comfort. In addition, the invention finish by providing less thickness, allows for alternative drape effects.

As to bending, bending is restricted with the use of invention compared to the standard finish. The invention finish adds to the strength of the woven matrix. While our bending is less than the standard finish, it is within the specifications of comfort from the fabric producer. The resistance to bending also adds to the longevity of the fabric.

As to surface, both surface variables, MIU and SMU, read positive for the invention finish. This refers to the smoothness of the fabric as well as providing a surface with less resistance, drag and friction. The invention finish provides a luxurious hand to the woven fabric compared to the standard finish.

As to shear and tensile strength, as with compression and bending, the strength properties confirm the invention finish's tendency to increase the strength properties of a woven fabric. Recovery from being stretched is improved with the invention finish, leading to longer garment life (via durability to laundering and use). Also improved are shear properties.

Specifically, it is seen generally in connection with Examples 1-10 that the inventive treatment provides a 150° bending value of B, gf-cm²/cm of from 0% to 40% higher than a like fabric which is untreated. In some preferred cases, the 150° bending value is from 5%-20% higher than a like untreated fabric.

With regard to surface smoothness, it is seen generally the invention provides lower SMD values indicating a smoother surface, anywhere from 0% or 5% to 15% lower SMD than a like untreated fabric in many cases.

Strength or resistance to stretch increased as indicated by an EMT value anywhere from 0%-30% or 5%-20% lower as compared with an untreated like fabric; lower stretch recovery increased as indicated by higher RT values anywhere from 0%-30% or 5%-15% higher than a like untreated fabric.

Shear resistance also generally increases as indicated by higher G values, anywhere from 0%-50% or 5%-20% as compared with a like untreated fabric.

### EXAMPLES 11-13

Knit polyester fabrics were prepared and tested as generally described above. The Example 11 and 12 specimens were treated with the polyvinyl acetate/ethylene PVOH stabilized emulsion described above in connection with Examples 1-10 with about 20 g/l of the as-is material. The Example 11 material was also treated with a softener, 20 g/l silicone based cationic softener (25% solids). Example 13 was untreated with the invention furnish.

Results appear in Tables 8 through 13.

TABLE 8
Summary of Mechanical Hand Properties

| | Example | | |
|---|---|---|---|
| Property | 11 | 12 | 13 |
| Weight (oz/yd²) | 3.13 | 3.11 | * |
| Compression: EMC (%)^{a} | 24.42 | 24.45 | 28.50 |
| RC (%)^{b} | 34.44 | 35.24 | 31.61 |
| Thickness (mm) | 0.49 | 0.50 | 0.51 |
| Bending: B (gf * cm²/cm)^{c} | 0.0033 | 0.0034 | 0.0022 |
| Surface: MIU (—)^{d} | 00.30 | 0.28 | 0.29 |
| SMDD (micron)^{e} | 1.97 | 3.39 | 3.78 |
| Shear: G (gf/cm * degree)^{f} | 00.39 | 0.46 | 0.16 |
| Tensile: EMT (%)^{g} | 22.13 | 18.06 | 23.33 |
| RT (%)^{h} | 57.12 | 51.70 | 50.58 |

^{a}A high EMC value indicates greater compressability.
^{b}High values mean a higher percent recovery from being compressed.
^{c}Low B values indicate less stiffness or resistance to bending motions.
^{d}Lower MIU corresponds to less friction or resistance and drag.
^{e}Low SMD values indicate a smoother surface.
^{f}A low value indicates less resistance to shearing movements; soft, pliable, drapeable.
^{g}High EMT indicates a stretchier material.
^{h}A high value indicates greater recovery from having been stretched.
*No measurement due to odd shape and non-standard specimen size.

TABLE 9
Weight*

| Example | Replicate 1 | (oz/yd²) |
|---|---|---|
| 11 | 4.25 | 3.13 |
| 12 | 4.22 | 3.11 |
| 13 | ** | ** |

*20 × 20 cm sample.
** No measurement due to odd shape and non - standard specimen size.

KES Compression Data

| | | -- WC -- | -- RC^{a} -- | -- LC -- | | |
|---|---|---|---|---|---|---|
| | | Compressional | Compressional | Linearity of | -- EMC^{b} -- | |
| Example- | | Energy | Resilience | Compression | Compressibility | Thickness* |
| replicate | | (gf*cm/cm²) | (%) | (—) | (%) | (mm) |
| Example 11 | -1 | 0.25 | 36.92 | 0.86 | 23.23 | 0.49 |
| | -2 | 0.21 | 32.98 | 0.79 | 22.20 | 0.48 |
| | -3 | 0.26 | 33.41 | 0.73 | 27.81 | 0.51 |
| Avg. | | 0.24 | 34.44 | 0.79 | 24.42 | 0.49 |
| Example 12 | -1 | 0.26 | 32.38 | 0.72 | 27.67 | 0.52 |
| | -2 | 0.21 | 36.32 | 0.78 | 22.04 | 0.49 |
| | -3 | 0.24 | 37.01 | 0.82 | 23.65 | 0.49 |
| Avg. | | 0.24 | 35.24 | 0.77 | 24.45 | 0.50 |
| Example 13 | -1 | 0.26 | 31.24 | 0.74 | 27.81 | 0.50 |
| | -2 | 0.27 | 31.58 | 0.68 | 29.96 | 0.53 |
| | -3 | 0.26 | 32.01 | 0.73 | 27.72 | 0.52 |

| | | | | | |
|---|---|---|---|---|---|
| Avg. | 0.26 | 31.61 | 0.72 | 28.50 | 0.51 |

*Thickness of a 2 cm² area at 0.5 gf/cm².
^{a}Higher values mean higher percent recovery from being compressed.
^{b}Higher values indicate greater compressibility.

TABLE 10
KES Bending Data*

| | |
|---|---|
| | 2HB^{b} |
| B^{a} | Hysteresis of |
| Bending Rigidity | Bending Momentum |
| (gf * cm²/cm) | (gf * cm/cm) |

| Example | (L) | (C) | (L) | (C) |
|---|---|---|---|---|
| Example 11 | | | | |
| -1 | 0.0037 | 0.0030 | 0.0045 | 0.0025 |
| -2 | 0.0050 | 0.0012 | 0.0069 | 0.0018 |
| Av. | 0.0044 | 0.0021 | 0.0057 | 0.0022 |

| | | |
|---|---|---|
| L + C | 0.0033 | 0.0040 |

| | | | | |
|---|---|---|---|---|
| Exampl 12 | | | | |
| -1 | 0.0010 | 0.0030 | 0.0054 | 0.0044 |
| -2 | 0.0054 | 0.0040 | 0.0062 | 0.0038 |
| Avg. | 0.0032 | 0.0035 | 0.0058 | 0.0041 |

| | | |
|---|---|---|
| L + C | 0.0034 | 0.0050 |

| | | | | |
|---|---|---|---|---|
| Example 13 | | | | |
| -1 | 0.0020 | 0.0010 | 0.0041 | 0.0007 |
| -2 | 0.0020 | 0.0009 | 0.0040 | 0.0028 |
| -3 | 0.0021 | 0.0031 | 0.0036 | 0.0037 |
| -4 | 0.0047 | | 0.0055 | |
| Avg. | 0.0027 | 0.0017 | 0.0043 | 0.0024 |

| | | |
|---|---|---|
| L + C | 0.0022 | 0.0034 |

Note:
L = lengthwise direction;
C = crosswise direction
^{a}Higher B value indicates greater stiffness/resistance to bending motions.
^{b}A larger 2HB value means greater fabric inelasticity.

TABLE 11
KES Surface Data

| | MIU^{a} | | MMD^{b} | | SMD^{c} | |
|---|---|---|---|---|---|---|
| | Coefficient of | | Mean Deviation | | Geometric | |
| | Friction | | of MIU | | Roughness | |
| Example - | (—) | | (—) | | (micron) | |
| replicate | (L) | (C) | (L) | (C) | (L) | (C) |
| Example 11 | | | | | | |
| -1 | 0.32 | 0.26 | 0.02 | 0.01 | 2.95 | 0.93 |
| -2 | 0.33 | 0.26 | 0.01 | 0.01 | 3.17 | 0.80 |
| Avg. | 0.33 | 0.26 | 0.02 | 0.01 | 3.06 | 0.87 |
| L + C | 0.30 | | 0.02 | | 1.97 | |
| Example 12 | | | | | | |
| -1 | 0.29 | 0.25 | 0.01 | 0.01 | 5.38 | 1.06 |
| -2 | 0.29 | 0.27 | 0.01 | 0.01 | 6.10 | 1.02 |
| Avg. | 0.29 | 0.26 | 0.01 | 0.01 | 5.74 | 1.04 |
| L + C | 0.28 | | 0.01 | | 3.39 | |
| Example 13 | | | | | | |
| -1 | 0.31 | 0.25 | 0.01 | 0.01 | 6.56 | 0.98 |
| -2 | 0.31 | 0.27 | 0.01 | 0.01 | 6.32 | 0.93 |
| -3 | 0.32 | 0.25 | 0.02 | 0.01 | 6.83 | 1.05 |
| Avg. | 0.31 | 0.26 | 0.01 | 0.01 | 6.57 | 0.99 |

| | | | |
|---|---|---|---|
| L + C | 0.29 | 0.01 | 3.78 |

Note:
L = lengthwise direction;
C = crosswise direction
^{a}Values from 0 to 1 with higher values corresponding to higher friction, indicating a smoother surface.
^{b}Higher value correspond to larger variations of friction.
^{c}Higher values mean a geometrically rougher surface.

TABLE 12
Detailed KES Shear Test Data

| | | | 2 HG | | | |
|---|---|---|---|---|---|---|
| | | | Hysteresis of | | 2HG5 | |
| | | | Shear Force @ | | Hysteresis of | |
| | G^{a} | | 0.5 Degrees of | | Shear Force @ | |
| | Shear Stiffness | | Shear Angle | | 5.0 Degree of | |
| Example - | (gf/cm · Degree) | | (gf/cm) | | Shear Angle | |
| replicate | (L) | (C) | (L) | (C) | (L) | (C) |
| Example 11 | | | | | | |
| -1 | 0.44 | 0.35 | 0.91 | 0.93 | 0.89 | 0.95 |
| -2 | 0.44 | 0.31 | 0.88 | 1.03 | 0.85 | 0.94 |
| Avg. | 0.44 | 0.33 | 0.90 | 0.98 | 0.87 | 0.95 |
| L + C | 0.39 | | 0.94 | | 0.91 | |
| Example 12 | | | | | | |
| -1 | 0.51 | 0.42 | 1.40 | 1.63 | 1.29 | 1.45 |
| -2 | 0.50 | 0.38 | 1.45 | 1.77 | 1.37 | 1.55 |
| Avg. | 0.51 | 0.40 | 1.43 | 1.70 | 1.33 | 1.50 |
| L + C | 0.46 | | 1.57 | | 1.42 | |
| Example 13 | | | | | | |
| -1 | 0.16 | 0.16 | 0.49 | 0.63 | 0.48 | 0.58 |
| -2 | 0.16 | 0.15 | 0.49 | 0.63 | 0.47 | 0.57 |
| Avg. | 0.16 | 0.16 | 0.49 | 0.63 | 0.48 | 0.58 |

| | | | |
|---|---|---|---|
| L + C | 0.16 | 0.56 | 0.53 |

Note:
L = lengthwise direction;
C = crosswise direction
^{a}Higher value means greater stiffness/resistance to shearing movement.

TABLE 13
Detailed LES Tensile Data

| | | | | | LT | | | |
|---|---|---|---|---|---|---|---|---|
| | | | | | Linearity of | | | |
| | WT | | RT^{a} | | Load- | | | |
| | Tensile | | Tensile | | Extension | | EMT^{b} | |
| | Energy | | Resilience | | Curve | | Extensibility | |
| Eample - | (gf · cm/cm²) | | (%) | | (—) | | (%) | |
| replicate | (L) | (C) | (L) | (C) | (L) | (C) | (L) | (C) |
| Example 11 | | | | | | | | |
| -1 | 1.78 | 6.28 | 60.65 | 50.12 | 0.68 | 0.69 | 10.45 | 36.25 |
| -2 | 1.65 | 6.69 | 59.32 | 58.37 | 0.70 | 0.83 | 9.38 | 34.40 |
| Avg. | 1.72 | 6.49 | 59.99 | 54.25 | 0.69 | 0.76 | 9.92 | 34.33 |
| L + C | 4.11 | | 57.12 | | 0.73 | | 22.13 | |
| Example 12 | | | | | | | | |
| -1 | 1.84 | 4.42 | 56.05 | 42.44 | 0.64 | 0.73 | 11.51 | 24.12 |
| -2 | 1.69 | 5.04 | 58.21 | 50.09 | 0.69 | 0.75 | 9.79 | 26.80 |
| Avg. | 1.77 | 4.73 | 57.13 | 46.27 | 0.67 | 0.74 | 10.65 | 25.46 |
| L + C | 3.25 | | 51.70 | | 0.71 | | 18.06 | |
| Example 13 | | | | | | | | |
| -1 | 5.20 | 2.53 | 40.70 | 61.91 | 0.72 | 0.68 | 28.94 | 14.95 |
| -2 | 5.42 | 2.53 | 37.79 | 61.91 | 0.63 | 34.47 | 14.95 | |
| Avg. | 5.31 | 39.25 | 0.68 | 0.67 | 31.71 | | | |

| | | | | |
|---|---|---|---|---|
| L + C | 3.92 | 50.58 | 0.68 | 23.33 |

Note:
L = lengthwise direction;
C = crosswise direction
^{a}Higher value indicates better recovery from deformation of strain.
^{b}Strain at maximum load with 100% = complete elasticity and 0% = complete inelasticity.

### EXAMPLE 14

In the case of “anti-wrinkling” finishes, a common test method from the American Association of Textile Chemists and Colorists (AATCC) can be used. AATCC Test Method 124-2006 “Appearance of Fabrics after Repeated Home Laundering” was used for post molded and post laundered bra cups. While this test method is commonly used to evaluate durable press (DP) finishing of flat fabrics, it can also be used to judge the laundered appearance of a bra cup. Defined properly, a “wrinkle” in a bra cup can be labeled as a laundered crease, or “sharp folds or lines running in any direction in a washed or dried specimen” . . . . Laundering creases are an unintended result of the restricted movement of specimens in a washer or the dryer. In the special case of bra cups, creases begin in the weak points of the polyurethane foam inner cup component. Both the mechanical action of a laundry machine, as well as the uneven drying of water in the dryer lead to channels, long vertical areas of less foam density, that have a weaker strength. These channels will eventually lead to folding in laundering processes. The folding continues to lead to more channels, and so on. Eventually, the amount of wrinkles that appear effect the product appearance, fashion and ultimately physical comfort of the consumer. It has been found that a range of 0.05% to 0.5% of TruModa 711 finish (a vinyl acetate emulsion polymer available from Celanese Emulsion Polymers—Dallas, Tex.) on the bra liner reduces laundered creasing. The % recovery of compression and higher tensile strength properties of the bra cup liner help in aiding dimensional stability of the foam during wetting (laundering) and drying phases of home laundering. Anti-wrinkling production example:

| | | | Smoothness |
|---|---|---|---|
| Specimen | | Number of | Appearance |
| Set No. | Treatment/Garment | Launderings | Rating |
| 1 | None | 10 | 1 |
| 2 | Trumoda 0.5% solids | 10 | 3.5 |
| | pad bath/bra | | |
| 3 | Trumoda 0.5% solids | 15 | 2.0 |
| | pad bath/bra | | |
| 4 | Trumoda 0.5% solids | 25 | 1.5 |
| | pad bath/bra | | |

Specimens from Sets 2-4 were treated with 10 g/L of Trumoda 0.5%, processed at a speed of 23.8 meters per minute and dried at a temperature of 170° C. for 29 seconds. The Smoothness Appearance Rating Scale ranges from 1-5 with 1 being a poor result and 5 being a good result.

It is apparent from the foregoing that the inventive method and products are intended for apparel generally. Because of the versatility and ability to provide body and strength to fabrics, the inventive method and products are also suitable for specialty undergarments. Undergarments or underwear are clothes worn under other clothes, often next to the skin. Underwear is worn for a variety of reasons. They keep outer garments from being soiled by perspiration. Women's brassieres provide support for their breasts, and men's briefs serve the same function for the male genitalia; a corset may be worn as a foundation garment to alter a woman's body shape. For additional support and protection when playing sports, men often wear more tightly fitting underwear, including jockstraps and trunks. Women may wear sports bras which provide greater support, thus increasing comfort and reducing the chance of damage to the ligaments of the chest during high-impact exercises such as jogging. Underwear can be used to preserve the wearer's modesty—for instance, some women wear camisoles and slips (petticoats) and the like under clothes that are sheer or tight-fitting. Because of a unique set of physical properties, the products of the invention are comfortable enough to be worn next to the skin and yet provide enough body and tensile strength to provide support and/or resist overly revealing deformation of the fabric.

Overall, it is seen the fabric with the invention finish has a unique comfort-related property profile. Also provided are unique appearance attributes such s luster, shine, matte and clarity to the textile surface.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

1. A method of finishing a textile comprising the steps of:
a. preparing an aqueous finishing liquor comprising from 0.05 wt. % solids to 65 wt. % solids of a finishing resin selected from the group comprising: vinyl acetate emulsion resins, including copolymers such as vinyl acetate ethylene emulsions, vinyl acetate acrylics, acrylic emulsions, polyvinyl alcohol resins, including polyvinyl alcohol vinyl formamide copolymers, polyvinyl alcohol vinyl amine copolymers, sulfonic acid functionalized polyvinyl alcohol resins, modified polyvinyl alcohol resins generally; and mixtures thereof;
b. saturating the textile with the finishing liquor to incorporate the liquor into the textile so as to provide a wetted textile; and
c. processing the wetted textile at elevated temperature under conditions which are controlled such that the finishing resin is inter-associated with the fibers of the textile; wherein the finishing resin is durably and uniformly inter-associated with the textile fiber surfaces at an add-on level of from 0.05 wt. % to less than 65 wt. % and is operative to alter at least one comfort-related property of the textile.

2. The method according to claim 1, wherein the finishing resin is a vinyl acetate emulsion resin.

3. The method according to claim 1, wherein the finishing resin is a vinyl acetate/ethylene copolymer emulsion.

4. The method according to claim 1, wherein the finishing resin is a self-crosslinking vinyl acetate ethylene emulsion resin.

5. The method according to claim 1, wherein the finishing resin includes a polyvinyl alcohol.

6. The method according to claim 1, wherein the finishing resin includes a hydrophobically modified polyvinyl alcohol resin.

7. The method according to claim 1, wherein the finishing resin is durably and uniformly inter-associated with the textile surfaces at an add-on level of from 0.1 wt. % to 5 wt. %.

8. The method according to claim 1, wherein the finishing resin is a resin selected from the group consisting of: polyvinyl alcohol vinyl formamide copolymers; vinyl amine copolymers; sulfonic acid functionalized polyvinyl alcohol resins and mixtures thereof.

9. The method according to claim 1, wherein the textile comprises cotton and the finishing resin comprises a polyvinyl alcohol vinyl formamide copolymer or a polyvinyl alcohol vinyl amine copolymer.

10. The method according to claim 1, wherein the finishing liquor comprises an additional resin selected from cellulosics and synthetic latexes such as SBR latex.

11. The method according to claim 1, wherein the finishing liquor includes wetting agents, anti-foam agents, softening agents, compatibilizers, starches, chelating agents, fixing agents, buffers, coating agents, binders, latexes, release finishes, enzymes, flame retardants, optical brightners, durable press agents, anti-microbial agents, uv-stabilizers and combinations thereof.

12. The method according to claim 1, wherein the finishing resin is inter-associated with the textile so as to improve the textile's durability to laundering.

13. The method according to claim 1, wherein the finishing resin is durably and uniformly inter-associated with the textile surfaces at an add-on level of from 0.1 wt. % to 2.5 wt. %.

14. The method according to claim 1, wherein the finishing resin is durably and uniformly inter-associated with the textile surfaces at an add-on level of from 0.1 wt % to 1 wt. %.

15. The method according to claim 1, wherein the finishing resin is durably and uniformly inter-associated with the fibers in film-form.

16. The method according to claim 1, wherein the textile is a woven fabric.

17. The method according to claim 1, wherein the textile is a knitted fabric.

18. The method according to claim 1, wherein the textile is a fabric comprising a blend of a natural fiber a blend of a synthetic fiber or a blend of both.

19. The method according to claim 1, wherein the textile is a fabric comprising a blend of cotton fiber and polyester fiber.

20. The method according to claim 1, wherein the textile treated is a finished garment.

21. The method according to claim 1, wherein the aqueous finishing further comprises an external crosslinker.

22. The method according to claim 1, wherein the wetted textile is processed at a temperature above 125° F. and less than 450° F.

23. The method according to claim 1, wherein the wetted textile is processed at a temperature above 140° F. and less than 450° F.

24. The method according to claim 1, wherein the wetted textile is processed at a temperature above 150° F. and less than 450° F.

25. The method according to claim 1, wherein the wetted textile is processed at a temperature above 212° F. and less than 450° F.

26. The method according to claim 1, wherein the finishing resin is a self-crosslinking vinyl acetate ethylene emulsion resin and the textile is processed at a temperature above 250° F. and less than 450° F. in order to cure the resin.

27. The method according to claim 1, wherein the textile is saturated by immersion in a bath of the finishing liquor and the finishing liquor is partially removed from the textile by compressing the wetted structure with squeeze rolls.

28. The method according to claim 1, wherein the textile is saturated by immersion in a bath of the finishing liquor at a temperature in the range of 125° F. to 450° F.

29. The method according to claim 1, wherein the textile is saturated by immersion in a bath of the finishing liquor at a temperature in the range of 140° F. to 450° F.

30. The method according to claim 1, wherein the textile is saturated by immersion in a bath of the finishing liquor at a temperature in the range of 200° F. to 450° F.

31. The method according to claim 1, wherein the finishing liquor comprises from 0.05 wt. % solids to 50 wt. % solids of the finishing resin.

32. The method according to claim 1, wherein the finishing liquor comprises from 0.05 wt. % solids to 40 wt. % solids of the finishing resin.

33. The method according to claim 1, wherein the finishing liquor comprises from 0.05 wt. % solids to 30 wt. % solids of the finishing resin.

34. The method according to claim 1, wherein the finishing liquor comprises from 0.05 wt. % solids to 20 wt. % solids of the finishing resin.

35. The method according to claim 1, wherein the finishing liquor comprises from 0.05 wt. % solids to 10 wt % solids of the finishing resin.

36. The method according to claim 1, wherein the finishing liquor comprises from 0.05 wt. % solids to 5 wt. % solids of the finishing resin.

37. The method according to claim 1, further comprising treating the fabric with infra-red radiation and/or microwaves.

38. The method according to claim 1, wherein the finishing resin comprises an ultra-violet light curable composition and further comprising irradiating the wetted fabric with UV light.

39. The method according to claim 1 wherein the finishing liquor is operative to impart no detrimental color change and/or improve the CIEL*a*b* value of textile.

40. The method according claim 1 wherein the finishing liquor is operative to impart Appearance properties, in particular improving luster of textile.

41. The method according to claim 1 wherein the finishing liquor is operative to improve the feel of the textile, in particular the thickness.

42. The method according to claim 1 wherein the finishing liquor is operative to impart moisture transport properties to the textile.

43. The method according to claim 1 wherein the finishing liquor is operative to impart hand to the textile, in particular smoothness.

44. The method according to claim 1 wherein the finishing liquor is operative to impart strength properties to the textile, such as but not limited to shear, burst, and tensile strength.

45. The method according to claim 1 wherein the finishing liquor is operative to impart heat transfer properties to the textile.

46. The method according to any claim 1 wherein the finishing liquor is operative to impart durability and longevity through improvement of compression and recovery of compression properties of the textile.

47. The method according to claim 1 wherein the finishing liquor is operative to impart bending properties to the textile.

48. The method according claim 1 wherein the finishing liquor is operative to impart no detrimental effect on dimensional stability of the textile.

49. The method according to claim 1 wherein the finishing liquor is operative to impart no detrimental effect or improves on ink receptivity of textile.

50. A method of finishing a textile comprising:
a. preparing an aqueous finishing liquor comprising from 0.05 wt. % solids to 5 wt. % solids of a finishing resin selected from the group consisting of: vinyl acetate emulsion resins, including copolymers such as vinyl acetate ethylene emulsions or vinyl acetate acrylic, acrylic emulsions, polyvinyl alcohol resins, including polyvinyl alcohol vinyl formamide copolymers, vinyl amine copolymers, sulfonic acid functionalized polyvinyl alcohol resins, modified polyvinyl alcohol resins generally; and mixtures thereof;
b. saturating the textile with the finishing liquor to incorporate the liquor into the textile so as to provide a wetted textile; and
c. processing the wetted textile at elevated temperature under conditions which are controlled such that the finishing resin is inter-associated with the fibers of the textile; wherein the finishing resin is durably and uniformly inter-associated with the textile fiber surfaces at an add-on level of from 0.05 M. % to less than 10 wt. % and is operative to alter at least one comfort-related property of the textile.

51. The method according to claim 50, wherein the finishing liquor comprises from 0.1 wt. % solids to 2.5 wt. % solid of the finishing resin.

52. The method according to claim 50, wherein the finishing liquor comprises from 0.1 wt. % solids to 1 wt. % solid of the finishing resin.

53. A method of concurrently dyeing or tinting and finishing a textile which is a blend of natural and synthetic fiber, the method comprising the steps of:
a. preparing an aqueous finishing liquor comprising from 0.05 wt. % solids to 40 wt. % solids of a finishing resin selected from the group consisting of: vinyl acetate emulsion resins, including copolymers such as vinyl acetate ethylene emulsions or vinyl acetate acrylic emulsions, polyvinyl alcohol resins, including polyvinyl alcohol vinyl formamide copolymers, vinyl amine copolymers, sulfonic acid functionalized polyvinyl alcohol resins, modified polyvinyl alcohol resins generally; and mixtures thereof, as well as at least one dye being a first dye;
b. saturating the blended textile with the finishing liquor to incorporate the liquor into the textile so as to provide a wetted textile; and
c. processing the wetted textile at elevated temperature under conditions which are controlled such that the finishing resin is inter-associated with the fibers of the textile and the dye is affixed to the textile; wherein the finishing resin is durably and uniformly inter-associated with the textile fiber surfaces at an add-on level of from 0.05 wt. % to less than 40 wt. % and is operative to alter at least one comfort-related property of the textile.

54. The method according to claim 53, wherein the fabric is a blend of polyester yarn and cotton yarn.

55. The method according to claim 53, wherein the finishing liquor contains a second dye.

56. The method according to claim 55, wherein the first dye is selectively applied to the natural fiber, and the second dye is selectively applied to the synthetic fiber or vice versa.

57. A textile finished with a finishing resin selected from: vinyl acetate emulsion resins, including copolymers such as vinyl acetate ethylene emulsions or vinyl acetate acrylic emulsions, acrylic emulsions, polyvinyl alcohol resins, including polyvinyl alcohol vinyl formamide copolymers, vinyl amine copolymers, sulfonic acid functionalized polyvinyl alcohol resins, modified polyvinyl alcohol resins generally; and mixtures thereof at an add-on level of from 0.05 wt. % to less than 65 wt. % wherein the finishing resin is durably and uniformly inter-associated with the textile fiber surfaces and is operative to alter at least one comfort-related property of the textile.

58. The finished textile according to claim 57, wherein the finishing resin is a vinyl acetate emulsion resin.

59. The finished textile according to claim 57, wherein the finishing resin is a vinyl acetate/ethylene copolymer emulsion.

60. The finished textile according to claim 57, wherein the finishing resin is a self-crosslinking vinyl acetate ethylene emulsion resin.

61. The finished textile according to claim 57, wherein the finishing resin comprises a polyvinyl alcohol having a molecular weight (Mw) of from 1,000 to 1,000,000.

62. The finished textile according to claim 57, wherein the finishing resin comprises a polyvinyl alcohol having a molecular weight (Mw) of from 10,000 to 500,000.

63. The finished textile according to claim 57, wherein the finishing resin is a resin selected from the group consisting of: polyvinyl alcohol vinyl formamide copolymers; vinyl amine copolymers; sulfonic acid functionalized polyvinyl alcohol resins and mixtures thereof.

64. The finished textile according to claim 57, wherein the textile comprises cotton and the finishing resin comprises a polyvinyl alcohol vinyl formamide copolymer or a polyvinyl alcohol vinyl amine copolymer.

65. The finished textile according to claim 57, wherein the finished textile further comprises a latex or cellulosic resin.

66. The finished textile according to claim 57, wherein the finishing resin is durably and uniformly inter-associated with the fibers in film-form.

67. The finished textile according to claim 57, wherein the finishing resin is durably and uniformly inter-associated with the textile surfaces at an add-on level of from 0.1 wt. % to 55 wt. %.

68. The finished textile according to claim 57, wherein the finishing resin is durably and uniformly inter-associated with the textile surfaces at an add-on level of from 0.1 wt. % to 45 wt. %.

69. The finished textile according to claim 57, wherein the textile is a woven fabric.

70. The finished textile according to claim 57, wherein the textile is a knitted fabric.

71. The finished textile according to claim 57, wherein the textile is a fabric comprising a blend of natural and synthetic fiber.

72. The finished textile according to claim 71, wherein the textile is a fabric comprising a blend of cotton yarn and polyester yarn.

73. The finished textile according to claim 57, wherein the finishing resin is durably and uniformly inter-associated with the textile surfaces at an add-on level of from 0.05 wt. % to less than 50 wt. %.

74. The finished textile according to claim 57, wherein the finishing resin is durably and uniformly inter-associated with the textile surfaces at an add-on level of from 0.05 wt. % to less than 40 wt. %.

75. The finished textile according to claim 57, wherein the finishing resin is durably and uniformly inter-associated with the textile surfaces at an add-on level of from 0.05 wt % to less than 30 wt. %.

76. The finished textile according to claim 57, wherein the finishing resin is durably and uniformly inter-associated with the textile surfaces at an add-on level of from 0.05 wt. % to less than 20 wt %.

77. The finished textile according to claim 57, wherein the finishing resin is durably and uniformly inter-associated with the textile surfaces at an add-on level of from 0.05 wt % to less than 15 wt. %.

78. The finished textile according to claim 57, wherein the textile is a conformable fabric with an add-on of finishing resin of from 10 wt. % to 50 wt. % wherein the fabric is suitable for masking anatomical detail when worn.

79. The finished textile according to claim 57 wherein the textile is a synthetic/natural fiber fabric provided with an add-on of from 5 wt. % to 50 wt. % that is capable of providing a sueded/textured surface upon brushing or sanding without further mechanical processing.

80. The finished textile according to claim 57, wherein the finishing resin is durably and uniformly inter-associated with the textile surfaces at an add-on level of from 0.05 wt. % to 10 wt. %.

81. The finished textile according to claim 57, wherein the finishing resin is durably and uniformly inter-associated with the textile surfaces at an add-on level of from 0.1 wt. % to 5 wt. %.

82. The finished textile according to claim 57, wherein the finishing resin is durably and uniformly inter-associated with the textile surfaces at an add-on level of from 0.1 wt. % to 2.5 wt. %.

83. The finished textile according to claim 57, wherein the finishing resin is durably and uniformly inter-associated with the textile surfaces at an add-on level of from 0.1 wt. % to 1 wt. %.

84. The finished textile according to claim 57, wherein the finishing resin comprises a polyvinyl acetate.

85. The finished textile according to claim 57, wherein the finishing resin comprises a polyvinyl alcohol.

86. A process for depositing an anti-wrinkle finish on an intimate garment comprising the steps of:
a. loading a textile into a stenter frame;
b. padding an aqueous finishing liquor comprising from 0.05 wt. % solids to 65 wt. % solids of a finishing resin selected from the group comprising: vinyl acetate emulsion resins, including copolymers such as vinyl acetate ethylene emulsions, vinyl acetate acrylics, acrylic emulsions, polyvinyl alcohol resins, including polyvinyl alcohol vinyl formamide copolymers, polyvinyl alcohol vinyl amine copolymers, sulfonic acid functionalized polyvinyl alcohol resins, modified polyvinyl alcohol resins generally; and mixtures thereof, onto the textile to incorporate the liquor into the textile and provide a wetted textile;
c. passing the wetted textile through a nip roller at a speed and a pressure to inter-associate the finishing resin with the fibers of the textile and remove excess finishing liquor out of the wetted textile, wherein the finishing resin is durably and uniformly inter-associated with the textile fiber surfaces at an add-on level of from 0.05 wt. % to less than 65 wt. %;
d. drying the wetted textile at a temperature for a length of time to provide a finished textile;
e. cutting the finished textile to create an inner lining and an outer lining of an intimate garment;
f. covering an inner layer having an inner side and an outer side wherein the inner lining covers the inner side and the outer lining covers the outer side of the inner layer;
g. molding the inner lining and the outer lining to the inner layer at a temperature for a length of time to provide an intimate garment.

87. The process of claim 86 wherein the wetted textile passes through the nip roller at a speed in the range of 15 to 25 meters/minute and a pressure in the range of 0.8 to 1.2 bar.

88. The process of claim 86 wherein the wetted textile is dried for a length of time ranging from 10 to 60 seconds at a temperature in the range of 125 to 200° C.

89. The process of claim 86 wherein the molding takes place for a length of time ranging from 60 to 180 seconds at a temperature in the range of 140 to 200° C.

90. The process of claim 86 wherein the finishing resin is a vinyl acetate emulsion resin.

91. The process of claim 90 wherein the vinyl acetate emulsion resin is a 0.5% solid solution.

92. The process of claim 86 wherein the finishing resin is durably and uniformly inter-associated with the textile fiber surfaces at an add-on level of from 35 wt % to less than 40 wt. %.

93. The process of claim 86 wherein the textile is a knit fabric comprising a synthetic fiber.

94. The process of claim 91 wherein the synthetic fiber being a polyester fiber.

95. The process of claim 86 wherein the finishing liquor includes wetting agents, anti-foam agents, softening agents, compatibilizers, starches, chelating agents, fixing agents, buffers, coating agents, binders, latexes, release finishes, enzymes, flame retardants, optical brightners, durable press agents, anti-microbial agents, uv-stabilizers and combinations thereof.

96. The process of claim 86 wherein the finishing liquor is operative to impart appearance properties, in particular improving luster of textile.
